(19) United States
(12) Patent Application Publication
(10) Pub. No.: US 2003/0214131 A1
(43) Pub. Date: Nov. 20, 2003

(54) Coupling-equipped pipe and apparatus for manufacturing the same

(76) Inventor: Shigeki Kanao, Nishinomiya-shi (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/423,025

(22) Filed: Apr. 25, 2003

(30) Foreign Application Priority Data
Apr. 26, 2002 (JP) 2002-125681
Nov. 8, 2002 (JP) 2002-324745
Jan. 17, 2003 (JP) 2003-009015
Mar. 14, 2003 (JP) 2003-069718

(51) Int. Cl. F16L 33/00

(52) U.S. Cl. 285/238

(57) ABSTRACT

The present invention relates to provide a coupling-equipped pipe which prevents cost increasing, and which also enables to perform connection work quickly and easily, and enables to stop water leakage in a secure manner. A coupling-equipped pipe 4 is constructed by inserting, into one end of a pipe main body 1 made of a synthetic resin and formed in a spiral shape wherein projecting parts 1A and recessed parts 1B are alternately positioned in the axial direction of the pipe, a tubular metal socket 2 having an external diameter larger than the internal diameter of the pipe main body, and inserting into the other end of the pipe main body 1, a tubular metal spigot 3 having an external diameter larger than the internal diameter of the pipe main body 1, and which has a tip end insertion part 3X capable being inserted into the socket 2 and connected therewith.

### BACKGROUND OF THE INVENTION

1. Field of the Invention

The present invention relates to a coupling-equipped pipe which is made of a synthetic resin, which allows the quick and easy mutual connection of pipes which are formed in a spiral shape in which projecting parts and recessed parts are alternately positioned in the direction of the axis of the pipe, and which allows connection in a state in which water-tight properties are heightened, and more particularly relates to a coupling-equipped pipe which is advantageous for the mutual connection of large pipes made of a synthetic resin with an internal diameter of 1000 mm or greater, which are used to construct large pipe channels such as drainage pipe channels beneath roadways, drainage pipe channels for sewers and the like, and an apparatus for manufacturing the same.

2. Description of the Related Art

Concrete fume pipes are common as the abovementioned large pipes; in recent years, however, there has been an increase in the use of large pipes made of synthetic resins, which have a strength comparable to or greater than that of fume pipes, and which are advantageous in terms of durability, reduced weight, saving of labor during installation and the like.

Furthermore, almost all of these large pipes are pipes which not only have an internal diameter of 1000 mm or greater, but which also have a long length dimension of approximately 5 m (with transportation and installation being taken into account). In order to connect a plurality of such long large pipes of this size, a more or less Z-shaped notch 31 is formed in the end portion of the pipe 30 in the direction of connection of the end portion of another pipe 30, as shown in FIG. 31(b). As a result of the formation of a notch 31 in this manner, when two pipes 30 and 30 are caused to abut each other at one end, the end surfaces 31A of the projecting part 30A and recessed part 30B of one pipe 30 coincide with the end surfaces 31A of the projecting part 30A and recessed part 30B of the other pipe 30, so that these projecting parts 30A and recessed parts 30B form a continuous construction in the connection area as well. By arranging the pipes so that there is no difference in the spiral pitch, pairs of projections 33, 33 used to prevent slipping out which are disposed in the axial direction of the pipe (described later) can be securely inserted into the recessed parts 30B, 30B.

In a case where two pipes 30 and 30 formed as described above are to be connected, one (lower) metal half coupling 34 which has bolt holders 32 on both sides and projections 33 used to prevent slipping out in specified locations on the inside surface is first disposed in the planned location of the connection in a state in which a packing sheet 35 is disposed on the inside surface (upper side) as shown in FIG. 31(a); then, the two pipes 30 and 30 are disposed so that the abovementioned projections 33 enter the recessed parts 30B of the pipes 30, and so that the end surfaces 31A, 31A of the notches 31, 31 in the axial direction of the pipes are positioned directly above one another, as shown in FIG. 31(b). In this case, [the pipes 30, 30] are disposed so that no great gap is generated between the notches 31, 31 of the pipes 30, 30. Next, as is shown in FIGS. 31(c), 31(d) and 31(e), portions of the recessed parts 30B, 30B in the upper surfaces of the respective notches of the two pipes 30, 30 are filled with a water-stopping corking material 37 so that a water-stopping block 36 inside is covered in a state with no gaps, and so that [the corking material 37] is deposited to a height that is slightly higher than the upper ends of the projecting parts 30A; then, the packing sheet 35 is wrapped around the pipes 30 under sufficient tension, and is fastened by means of vinyl tapes 38, 38 or the like as shown in FIG. 31(f). Next, another (upper) half coupling 39 (which has the same construction as the abovementioned half coupling 34) is applied from above; afterward, bolts 40 are passed through the bolt holders 32, 32 positioned above and below on the two half couplings 34 and 39, and nuts 41 are screwed onto these bolts 40, thus drawing the upper and lower bolt holders 32, 32 together and tightening and fastening these bolt holders 32, 32 so that the connection of the two pipes 30, 30 is completed.

The following problems have been encountered in the abovementioned connection method:

(1) Besides the upper and lower half couplings 34 and 39, numerous materials such as the packing sheet 35, water-stopping block 36, water-stopping corking material 37 and the like are required, so that the total cost including warehousing control costs and shipping costs is high; furthermore, the handling of such numerous materials in the connection procedure requires time and effort.

(2) The insertion of the abovementioned projections 33 into the recessed parts 30B of the abovementioned pipes 30, and the disposal of the pipes 30 so that the end surfaces 31A of the notches 31 of the pipes 30 in the axial direction of the pipes, require an extremely large amount of labor; moreover, as numerous pipes 30 are connected (linked), it becomes difficult to dispose the pipes 30 so that the end surfaces 31A of the notches 31 of the pipes 30 in the axial direction of the pipes are positioned directly above one another as described above, because of assembly error and molding error of the notches in the connected terminal ends of the pipes 30, so that connection (linkage) work becomes difficult.

(3) Even if the notches 31 formed in the pipes are formed with good precision, the generation of a gap between the notches 31, 31 when two pipes are caused to abut each other cannot be completely eliminated; accordingly, depending on the magnitude of the water pressure, it may be impossible to stop water leakage in a secure manner.

A system in which a trough filling member which has shape retention properties is fastened beforehand to the end portions of the pipe main body, so that filling work in which two places on the end portions of the two abutted pipes with a corking material is made unnecessary, has been proposed as a system that solves the abovementioned problem (1) (for example, see Japanese Patent Application Laid-Open No. 2002-147661).

According to the abovementioned Japanese Patent Application Laid-Open No. 2002-147661, this system offers the advantage of accelerating the connection work to the extent that filling work involving filling with a corking material is made unnecessary. However, since work in which the packing sheet is wrapped around the pipes under sufficient tension is still required, this system does not provide a basic solution. Furthermore, since the abovementioned problems (2) and (3) cannot be solved, and early solution is desired.

### SUMMARY OF THE INVENTION

In light of the abovementioned conditions, it is an object of the present invention to provide a coupling-equipped pipe which prevents an increase in cost, and which also makes it possible to perform connection work quickly and easily, and makes it possible to stop water leakage in a secure manner.

In the present invention, in order to solve the abovementioned problems, a coupling-equipped pipe is made of a synthetic resin, and is constructed by inserting, into one end of a pipe main body which is formed in a spiral shape in which projecting parts and recessed parts are alternately positioned in the direction of the pipe axis, a tubular socket made of metal which has an external diameter that is larger than the internal diameter of said pipe main body, and by further inserting, into the other end of the pipe main body, a tubular spigot made of metal which has an external diameter that is larger than the internal diameter of said pipe main body, and which also has a tip-end insertion part that can be inserted into said socket and connected therewith; or, a coupling-equipped pipe is made of a synthetic resin, and is constructed by inserting, into one end of a pipe main body which is formed in a spiral shape in which projecting parts and recessed parts are alternately positioned in the direction of the pipe axis, a tubular socket made of metal which has an external diameter that is smaller than the internal diameter of said pipe main body, then expanding the diameter of at least a portion of said socket, and by further inserting, into the other end of said pipe main body, a tubular spigot made of metal which has an external diameter that is smaller than the internal diameter of the pipe main body, and which also has a tip-end insertion part that can be inserted into the socket and connected therewith, then expanding the diameter of at least a portion of the spigot.

In a case where pipes adjacent to each other in the axial direction of the pipes are to be connected to each other, the two pipes can be connected to each other at one end by inserting the spigot installed on one end of the connection side of the pipe main body of one of the pipes into the socket installed on one end of the pipe main body of the other pipe. Furthermore, a sealing material which is used to perform a sealing treatment between the two opening parts when the two opening parts are connected may be disposed on either the abovementioned socket or the abovementioned spigot, or on both opening parts, or a sealing treatment may be performed by filling the area between the two opening parts with a clay-form corking material, adhesive agent or the like after the connection of the two opening parts has been completed. Furthermore, the external diameters of the socket and spigot are set at a dimension that is slightly larger than the internal diameter of the pipe main body so that no large force which is such that the pipe main body undergoes a large defection (i.e., which is such that the elastic recovery force of the pipe main body is diminished) when the opening parts are inserted into the pipe main body acts on the pipe main body. Furthermore, in cases where the socket or spigot is inserted into the pipe main body so that a portion of the pipe main body is expanded in diameter, trouble such as a reduction in the elastic recovery force in the pipe main body (which occurs in the case of insertion as described above) can be avoided. Furthermore, besides constructing the abovementioned socket and spigot so that the external diameters of these opening parts are the same throughout the entire region in the direction of insertion, it would also be possible (for example) to use tubular members which have tapered surfaces (inclined surfaces) that are inclined outward toward the rear end with respect to the direction of insertion. In this case, the socket and spigot can easily be inserted into the pipe main body by constructing the socket and spigot so that the external diameters of these opening parts are larger than the internal diameter of the pipe main body only in the rear end portions of these opening parts with respect to the direction of insertion.

The strength of the pipe main body can be greatly increased by installing a plate-form metal reinforcing member in the form of a band on the projecting part of the abovementioned pipe main body. Furthermore, since an elastic recovery force is received from the metal reinforcing member in the state in which the socket and spigot are inserted into the pipe main body, this offers the advantage of allowing strong fastening of the socket and spigot to the pipe main body.

Furthermore, a coupling-equipped pipe may also be constructed in which the socket and spigot are respectively constituted by tubular bodies with a tapered shape that is tapered inward toward the tip end with respect to the direction of insertion, annular sealing members made of a fusible synthetic resin are provided to the outside surfaces of the tubular bodies, the tapered socket or spigot is inserted from the tip end into the pipe main body as far as a position where the diameter of the pipe main body is not thereby expanded, and in this inserted state, the socket or spigot is further inserted into the pipe main body, as far as a set position, while the sealing member is thermally fused or thermally deformed, whereby the end portion of the pipe main body is thermally deformed into a shape that spreads outward.

As a result of the tapered socket or spigot being inserted as described above into the pipe main body from the tip end as far as a position that does not expand the diameter of the pipe main body, and the sealing material being thermally fused or thermally deformed in this inserted state, a state is achieved in which the heat is also transmitted to the pipe main body, so that the pipe main body is easily deformed. As a result of the socket or spigot being inserted into the pipe main body as far as a set position in this state, the end portion of the pipe main body can be deformed into a shape that spreads outward without causing cracks or the like in this end portion.

Even in cases where there is variation in the internal diameter of the abovementioned pipe main body as a result of manufacturing error, or in cases where the [abovementioned] socket or spigot is mounted in a plurality of different pipe main bodies with more or less different internal diameters, especially pipe main bodies with internal diameters that are smaller than the specified dimension, the end portion of the pipe main body can be deformed into a shape that spreads outward without causing the generation of cracks or the like in this end portion by inserting the tapered socket or spigot as described above into the pipe main body from the tip end as far as a position that does not cause expansion of the diameter of the pipe main body, and then thermally fusing or thermally deforming the sealing material in this inserted state. Accordingly, this system is advantageous in that differences in the internal diameter of the pipe main body can be absorbed. Furthermore, in cases where the abovementioned sealing material is thermally fused or thermally deformed, it is desirable that this be accomplished by means of a high-frequency heating device disposed inside the socket or spigot that has be inserted to an intermediate point in the pipe main body. After the abovementioned socket or spigot has been inserted into the pipe main body as far as the set position, the tapered socket or spigot can be returned to a straight socket or spigot which has a more or less the same internal diameter at any position in the axial direction of the pipe by using pipe expanding means. Furthermore, the abovementioned “position that does not cause expansion of the diameter” refers to a position where the pipe main body is not even slightly deformed by the insertion of the socket or spigot into the pipe main body; in concrete terms, this refers to a position in which the inside surface of the end portion of the pipe main body is in contact with the outside surface of the socket or spigot, or is in a state that is close to such contact.

The connection work can be completed at the same time that the insertion of the socket and spigot is completed by disposing a sealing material (used to perform a sealing treatment between the two opening parts when the two opening parts are connected) on either the socket or the spigot, or on both opening parts.

By disposing recessed parts that are recessed inward in the direction of diameter of the pipe and projecting parts that protrude outward in the direction of diameter of the pipe on the abovementioned socket and spigot, and inserting the socket and spigot provided with such recessed parts and projecting parts into the abovementioned pipe main body, it is possible to dispose a socket and spigot in which the shape retention strength is greatly improved compared to opening parts that lack such recessed parts and projecting parts in the pipe main body, so that the strength of the end portions of the pipe main body can be improved.

By forming the abovementioned recessed parts with an annular shape, and constructing these recessed parts as attachment parts for attaching the sealing material that is used to accomplish sealing with respect to the abovementioned pipe main body, and by constructing the abovementioned projecting parts as regulating parts that are used to contact and regulate the positions where the socket and spigot are inserted into the abovementioned pipe main body, it is possible to reduce the number of parts required and to shorten the assembly process compared to cases in which such parts are formed as separate parts and attached to the socket and spigot.

By filling the spaces formed between the recessed parts of the abovementioned socket and spigot and the inside surface of the abovementioned pipe main body with a molten resin via one or more openings formed in the socket and spigot and solidifying this resin in a state in which the abovementioned socket and spigot are inserted into the pipe main body, the solidified resin members inside the spaces can be caused to function as members that prevent the movement of the socket and spigot relative to the pipe main body. In this case, if a covering layer consisting of a synthetic resin is disposed on the outside surfaces of the socket and spigot, the abovementioned filling molten resin will be melt-bonded to the pipe main body and the covering layer of the socket and spigot, so that a sealing treatment between the pipe main body and the socket and spigot can be accomplished. If the synthetic resin that forms the abovementioned covering layer, the synthetic resin that forms the pipe main body and the filling synthetic resin are all constructed from the same resin, the advantage of an increased adhesive force can be obtained.

A covering layer consisting of a synthetic resin may be disposed on the outside surfaces of the abovementioned socket and spigot.

It is desirable that the inside surface of the abovementioned pipe main body be formed as a flat surface.

The abovementioned recessed parts are formed with an annular shape, these recessed parts are constructed as attachment parts for the disposition of the sealing material used for sealing to the abovementioned pipe main body, the sealing material that is disposed inside these attachment parts is constructed from band-form members consisting of a synthetic resin that can be thermally fused to a metal, some or all of the abovementioned attachment parts are pressed and deformed outward in the direction of diameter of the pipe from the center of the pipe by pressing deformation means, and the abovementioned pipe main body and socket or spigot are connected by heating and fusing the band-form members inside the abovementioned attachment parts by means of a high-frequency heating device in a state in which the abovementioned attachment parts are deformed by the abovementioned pressing deformation means.

In addition to the socket or spigot being mounted in the pipe main body by engagement (by forcible insertion), or the socket or spigot being mounted by expanding the diameter [of the opening part] after the socket or spigot has been inserted into the pipe main body, the pipe main body and the socket or spigot are connected by using a high-frequency heating device to melt annular members consisting of a synthetic resin that can be fused to a metal. Furthermore, before the abovementioned annular members are melted by means of this high-frequency heating device, some or all of the attachment parts are pressed and deformed outward in the direction of diameter of the pipe from the center of the pipe by pressing deformation means, so that a state is obtained in which the annular members are pressed against the pipe main body in a state in which the pipe main body is also pressed and deffected outward in the direction of diameter of the pipe. As a result of the band-form members being melted by the high-frequency heating device in this state, the pressing force applied to the pipe main body is released, so that the band-form members receive a pressing force as a result of the recovery force that causes the pipe main body to return to its original state, thus causing the band-form members to be pressed against the attachment parts so that the strength of the connection between the pipe main body and the socket or spigot can be increased. Furthermore, it is desirable that the pressing force whereby some or all of the attachment parts are pressed and deformed outward in the direction of diameter of the pipe from the center of the pipe by the pressing deformation means as described above be set at a force which is such that the recovery force that causes the deformed synthetic resin (plastic) pipe main body to return to its original shape or a shape close to its original shape can be manifested.

The abovementioned sealing material is heated and melted by disposing a heating coil that constitutes the abovementioned high-frequency heating device inside the abovementioned socket or spigot.

By disposing the heating coil inside the socket or spigot as described above, it is possible to heat the socket or spigot more quickly than the pipe main body, so that trouble such as deformation of the pipe main body or the like can be avoided to a corresponding degree.

If the abovementioned band-form members are constructed by dispersing a conductive filler such as carbon black or the like in a synthetic resin, disposing a metal mesh on either the front surface or back surface, or on both surfaces, of a band-form main body consisting of a synthetic resin, or disposing such a metal mesh inside a band-form main body consisting of a synthetic resin, the time required for melting by the high-frequency heating device can be shortened; furthermore, melting can be accomplished with the heating temperature of the heating coil that constitutes the high-frequency heating device set at a lower temperature than in the case of a sealing material that is constructed from a synthetic resin alone.

A coupling-equipped pipe manufacturing apparatus comprises: a rotatable rotating stand capable of carrying a pipe main body which is made of a synthetic resin, and which is formed in a spiral shape in which projecting parts and recessed parts are alternately positioned in the axial direction of the pipe; insertion means for inserting a tubular socket or spigot which is made of a metal and has a sealing material consisting of a synthetic resin that can be thermally fused to a metal inside a recessed part that is recessed inward in the direction of diameter of the pipe, the insertion means being provided at one of the two ends of the pipe main body with respect to the axial direction of the pipe carried on the rotating stand; and heating coil insertion means provided at the other end of the pipe main body for inserting a heating coil that constitutes a high-frequency heating device into the pipe main body; wherein the apparatus further comprises: direction changing means which rotate the rotating stand after the socket or spigot has been inserted into the pipe main body by the insertion means so that the pipe main body is caused to undergo a change in direction of approximately 180 degrees; and thermal fusion means for causing thermal fusion of the sealing material after the heating coil has been inserted into the socket or spigot following the change in direction of the pipe main body.

When a coupling-equipped pipe is to be manufactured, either a socket or a spigot is first inserted into one end of the pipe main body placed on the rotating stand; then, by using the direction changing means to change the direction of the pipe main body by approximately 180 degrees, it is possible to position the end of the pipe main body into which the socket or spigot has been inserted in a position that faces the side of the heating coil. After the heating coil has been inserted into the socket or spigot by the thermal fusion means, the sealing material is heated and melted by driving the heating coil, so that the pipe main body and the socket or spigot are connected. While the pipe main body and socket or spigot are being connected by the abovementioned thermal fusion means, a spigot or socket is inserted into the other end of the pipe main body by the insertion means, and the pipe main body is caused to change direction by approximately 180 degrees by the direction changing means in the same manner as described above so that the end of the pipe main body into which the socket or spigot has been inserted is positioned facing the side of the heating coil. Afterward, the heating coil is inserted into the socket or spigot by the thermal fusion means, and the heating coil is then driven so that the sealing material is heated and melted, thus connecting the pipe main body and the socket or spigot so that a coupling-equipped pipe is constructed. Furthermore, when the socket or spigot is mounted in the pipe main body, the pipe main body is fastened in place using fastening means. It is desirable that the sealing material be constructed from a band-form material (band-form members) having a width in the axial direction of the pipe.

### BRIEF DESCRIPTION OF THE DRAWINGS

FIG. 1 is a partially cut-away side view of the coupling-equipped pipe;

FIG. 2 is an end surface view which shows the connection area where two of the coupling-equipped pipes shown in FIG. 1 are connected;

FIG. 3 is a partially cut-away side view which shows the connection area where two of the coupling-equipped pipes shown in FIG. 1 are connected;

FIGS. 4(a) through 4(f) are explanatory diagrams which show the procedure used to manufacture the coupling-equipped pipe;

FIG. 5 is a partially cut-away side view which shows the press-fitting device used to insert the spigot or socket into the pipe main body;

FIG. 6 is an end surface view which shows the connection area where two other coupling-equipped pipes are connected;

FIG. 7 is a partially cut-away side view which shows the connection area where the two coupling-equipped pipes sown in FIG. 6 are connected;

FIG. 8(a) is an end surface view which shows the connection area where two other coupling-equipped pipes are connected;

FIG. 8(b) is a sectional view of the essential parts in FIG. 8 (a);

FIG. 9 is a partially cut-away side view which shows the connection area where the two coupling-equipped pipes shown in FIG. 8 are connected;

FIG. 10(a) is an end surface view which shows the connection area where two other coupling-equipped pipes are connected;

FIG. 10(b) is a sectional view of essential parts in FIG. 10(a);

FIG. 11 shows end surface views which illustrate the state in which two coupling-equipped pipes are connected, with FIG. 11(a) showing a state in which the stopper member is installed in the spigot by means of a tool, FIG. 11(b) showing the point in time at which the tip end of the stopper member passes through the socket, and FIG. 11(c) showing a state in which the tool is removed from the stopper member;

FIG. 12 is a front view of the stopper member in a state in which the diameter is reduced by means of the tool;

FIG. 13 is an end surface view which shows the connection area where two other coupling-equipped pipes are connected;

FIG. 14 is a partially cut-away end surface view which shows essential parts of the connection area where the two coupling-equipped pipes shown in FIG. 13 are connected;

FIG. 15 is a partially cut-away end surface view which shows the essential parts of the connection area where two other coupling-equipped pipes constructed by installing means for preventing slipping out on the coupling-equipped pipes shown in FIG. 13 are connected;

FIG. 16 is a partially cut-away end surface view which shows the essential parts of the connection area where two coupling-equipped pipes of another construction are connected;

FIG. 17 shows end surface view of essential parts illustrating the procedure used to construct the coupling-equipped pipes shown in FIG. 16, with FIG. 17(a) showing a state in which the socket is inserted into the pipe main body, and FIGS. 17(b) and 17(c) showing a state immediately prior to the heating (by means of a high-frequency heating device) of the sealing material that is caused to adhere tightly to the pipe main body, with the location that is pressed being respectively varied in these figures;

FIGS. 18(a), 18(b) and 18(c) are end surface views showing a state in which the socket is inserted into the pipe main body in order to construct respective coupling-equipped pipes of other constructions;

FIG. 19(a) is an end surface view showing a state in which the socket is inserted into the pipe main body in order to construct a coupling-equipped pipe of another construction;

FIG. 19(b) is an end surface view showing a state following the insertion of the socket into the pipe main body as shown in FIG. 19(a);

FIG. 20 shows end surface view of a state in which another socket which has a recessed part formed in an intermediate portion of the socket with respect to the direction of length is mounted in the pipe main body, with FIG. 20(a) showing a state in which the socket is inserted into the pipe main body, and FIGS. 20(b) and 20(c) showing a state immediately prior to the heating (by means of a high-frequency heating device) of the sealing material that is caused to adhere tightly to the pipe main body, with the location that is pressed being respectively varied in these figures;

FIGS. 21(a) and 21(b) are end surface views showing a construction in which the sealing material is pressed against the pipe main body without pressing the socket;

FIGS. 22(a) and 22(b) are perspective views which show respective sealing materials of other constructions;

FIG. 23(a) is an enlarged end surface view which shows the detailed stated following the pressing of the socket into the pipe main body;

FIG. 23(b) is an enlarged end surface view showing a state in which the sealing material has been melted by the heating coil;

FIG. 24 is a schematic overall side view of the coupling-equipped pipe manufacturing apparatus;

FIG. 25 is a flow chart which shows the manufacturing procedure of the coupling-equipped pipe manufacturing apparatus;

FIG. 26 is a schematic overall side view of another coupling-equipped pipe manufacturing apparatus;

FIG. 27 is a schematic overall side view of another coupling-equipped pipe manufacturing apparatus;

FIG. 28 shows sectional views which illustrate the process by which the socket is mounted in the pipe main body, with FIG. 28(a) showing a state in which the socket has been inserted more or less half way into the pipe main body, and FIG. 28(b) showing a state immediately prior to the deformation into a straight shape of the tapered socket that has been inserted into the pipe main body;

FIG. 29 shows enlarged views of the essential parts shown in FIG. 28, with FIG. 29(a) showing a state in which the socket has been inserted more or less half way into the pipe main body, and FIG. 29(b) showing a state in which the socket has been inserted as far as the set position;

FIG. 30(a) is a side view of the socket; FIG. 30(b) is a side view of the spigot; and

FIG. 31 shows a conventional example of a method for connecting two pipes, with FIG. 31(a) showing a state in which the pipes are disposed on the lower half coupling, FIG. 31(b) showing a state in which the state shown in FIG. 31(a) is viewed from directly above, FIG. 31(c) showing a state immediately prior to the covering of the water-stopping block by the sealing material, FIG. 31(d) showing a state in which the water-stopping block is covered by the sealing material, FIG. 31(e) showing a state in which the sealing material has been disposed in a specified position, FIG. 31(f) showing a state in which the packing sheet has been wrapped around the pipes and fastened by tapes, and FIG. 31(g) showing a state in which the connection of the pipes has been completed.

### DESCRIPTION OF THE PREFERRED EMBODIMENTS

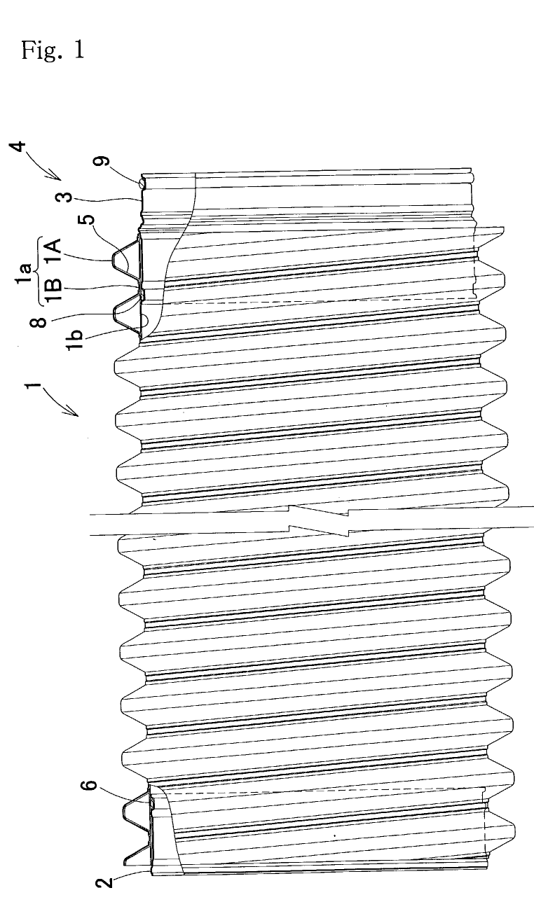

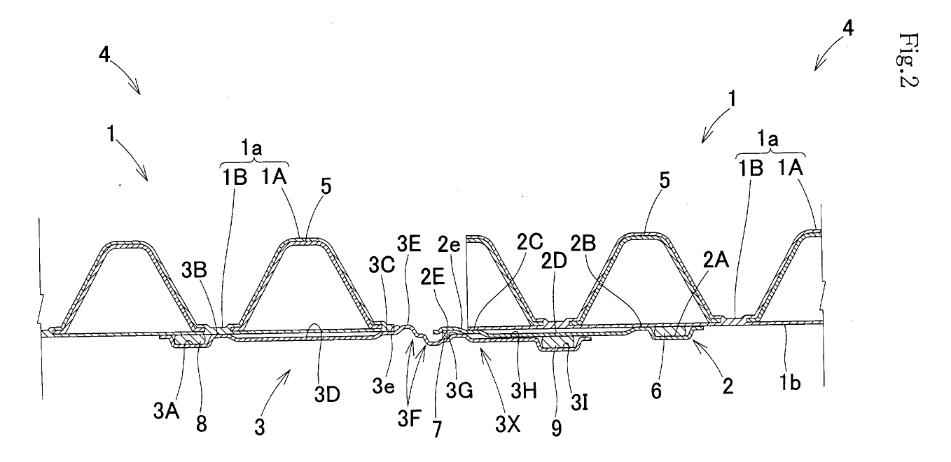

In FIGS. 1 and 2, a coupling-equipped pipe 4 is constructed by disposing a cylindrical socket (coupling) 2 in one end of a synthetic resin pipe main body 1 consisting of a high-density polyethylene (or some other material), and disposing a cylindrical spigot (coupling) 3 in the other end of this pipe main body 1. Furthermore, these figures show a state in which a socket 2 is disposed in one pipe main body 1, and a spigot 3 is disposed in another pipe main body 1. The abovementioned pipe main body 1 has an internal diameter of 1000 mm and a length of 5 m or more. However, this pipe main body 1 may have a diameter of less than 1000 mm; there are no restrictions on these dimensions. Furthermore, besides being used as a drainage pipe or sewer pipe, the abovementioned coupling-equipped pipe 4 may also be used as a pipe that is used to form a common electrical wire conduit or the like.

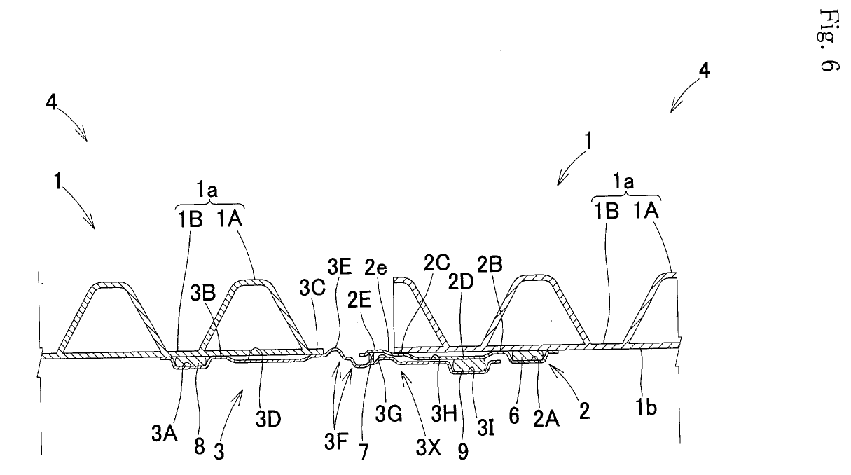

The abovementioned pipe main body 1 is constructed from an outside part 1a in which projecting parts 1A that have a more or less trapezoidal shape (these parts may have any shape, such as a circular arc shape, triangular shape, rectangular shape or the like) and recessed parts 1B that have a more or less flat surface are alternately positioned in the axial direction of the pipe and formed in a spiral configuration, and an inside part 1b which is used to form a flat inside surface by covering the undersurfaces of the abovementioned projecting parts 1A. Furthermore, in the case of a large-caliber pipe main body 1 of the type described above, the advantage of a greatly increased shape retention strength can be obtained by disposing metal reinforcing members 5 consisting of roughly trapezoidal zinc-plated steel plates (various types of metals can be used) between the inside surfaces of the outside part 1a and the outside surfaces of the inside part 1b. However, depending on the caliber of the pipe, intended use and the like, such metal reinforcing members 5 may be omitted (see FIG. 6). The reason that the inside surface of the pipe main body 1 is made more or less flat as described above is that this makes it possible to reduce the drainage resistance in cases where the pipe is used as a drainage pipe or sewer pipe. Furthermore, in cases where the pipe is used as a common electrical wire conduit, such a configuration offers the advantage of allowing smooth wiring work without the catching of tip ends [of the wires] when wires are run through the pipe main body 1. Moreover, when the abovementioned socket 2 and spigot 3 are inserted into the pipe main body 1, the inserted portions can be securely supported by the inside surface, and sealing can be securely accomplished.

As is shown in FIG. 2, the abovementioned socket 2 consists of a cylindrical metal member, and comprises an annular recessed part (groove part) 2A which is recessed inward at the base end part, a pair of annular first projecting parts 2B and 2C which are formed along the tip end portion from this recessed part 2A in order to make pressing contact with the inside surface of the pipe main body 1 in two places, an annular recessed part 2D which is formed between these first projecting parts 2B and 2C, and an annular second projecting part 2E which is formed as a protruding part that protrudes outward in the axial direction of the pipe from the end portion of the pipe main body 1, and which protrudes further outward than the inside surface of the pipe main body 1. These parts are arranged so that the shape retention strength of the socket 2 can be greatly improved. Furthermore, an annular sealing material 6 (with a length extending around the entire circumference pipe main body 1; it is advisable that this be constructed from a water-swellable rubber ring that swells when the ring contains water, but an ordinary sealing material may also be used) which has a more or less rectangular cross-sectional shape (in the figures, the contact area can be increased by construction in a rectangular shape so that the sealing performance can be improved compared to the case of a square shape) and which is used to achieve a seal with the inside surface of the pipe main body 1 is installed inside the abovementioned recessed part 2A, and an annular (this may have a partial shape) stopper member 7 (which may be omitted) used to contact and prevent slipping out of the spigot 3 (described later) is installed inside the abovementioned second projecting part 2E. Furthermore, the abovementioned recessed part 2A constitutes an attachment part that attaches the sealing material 6. Moreover, a regulating part which is used to contact and regulate the insertion position of the socket 2 with respect to the pipe main body 1 is constituted by an inclined part 2e of the abovementioned second projecting part 2E located on the side of the abovementioned first projecting part 2C.

As is shown in FIG. 2, the abovementioned spigot 3 is a cylindrical metal member which has a dimension in the axial direction of the pipe that is approximately twice that of the abovementioned socket 2 (as a result of the provision of a part that is inserted into the abovementioned socket 2); this spigot 3 comprises an annular recessed part (groove part) 3A which is recessed inward at the base part, a pair of annular first projecting parts 3B and 3C which are formed along the tip end portion from this recessed part 3A in order to make pressing contact with the inside surface of the pipe main body 1 in two places, an annular recessed part 3D which is formed between these first projecting parts 3B and 3C, and a tip-end insertion part 3X which protrudes greatly outward in the axial direction of the pipe form the end portion of the pipe main body 1. The abovementioned tip-end insertion part 3X consists of an annular second projecting part 3E which protrudes further outward than the inside surface of the pipe main body 1, a step part 3F which has two step parts formed in order to connect the insertion part which has a smaller diameter than the internal diameter of the socket 2 disposed on the tip end side of the abovementioned second projecting part 3E, a third projection part 3G which contacts the abovementioned stopper member 7 and thus contacts and stops the movement of the spigot 3 in the slip-out direction, a flat part 3H which is inserted and guided into the abovementioned socket 2, and a second recessed part 3I which is formed on the tip end. As a result of the provision of the recessed and projecting parts 3A through 3I as described above, the shape retention strength of the spigot 3 can be greatly improved. An annular sealing material 8 (with a length extending around the entire circumference pipe main body 1; it is advisable that this be constructed from a water-swellable rubber ring that swells when the ring contains water, but an ordinary sealing material may also be used) which has a more or less rectangular cross-sectional shape (in the figures, the contact area can be increased by construction in a rectangular shape so that the sealing performance can be improved compared to the case of a square shape) and which is used to achieve a seal with the inside surface of the pipe main body 1 is installed inside the first recessed part 3A positioned at the abovementioned base end part, and an annular sealing material 9 (this is ordinarily a rubber ring, but may also be a water-swellable rubber ring that swells when water is contained) which has a more or less rectangular cross section (in the figures, the contact area can be increased by construction in a rectangular shape so that the sealing performance can be improved compared to the case of a square shape) and which is used to perform a sealing treatment with the inside surface of the socket 2 is installed in the second recessed part 3I positioned at the abovementioned tip end portion. A regulating part which is used to contact and regulate the insertion position of the spigot 3 with respect to the pipe main body 1 is constituted by an inclined part 3e of the abovementioned second projecting part 3E located on the side of the abovementioned first projecting part 3C.

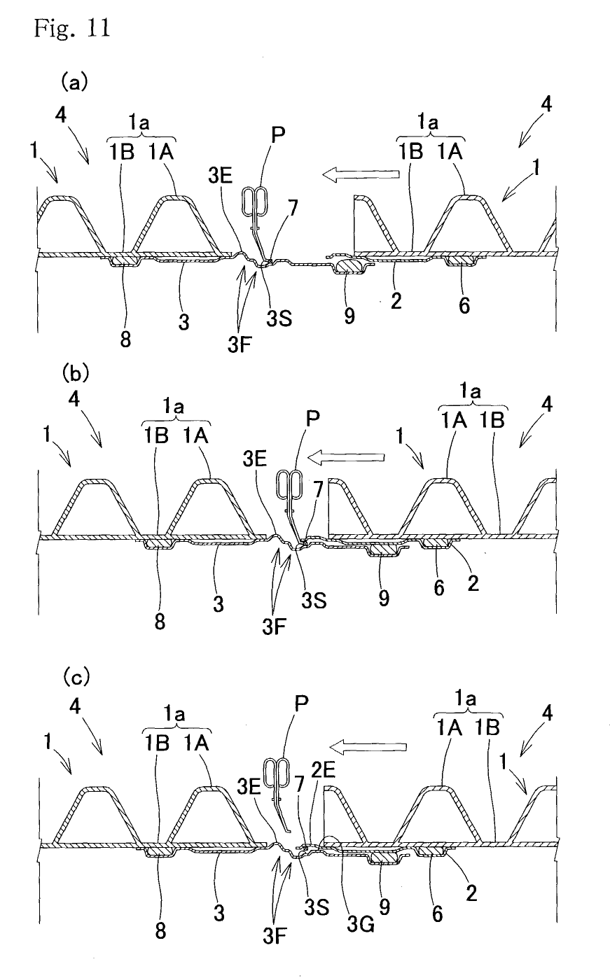

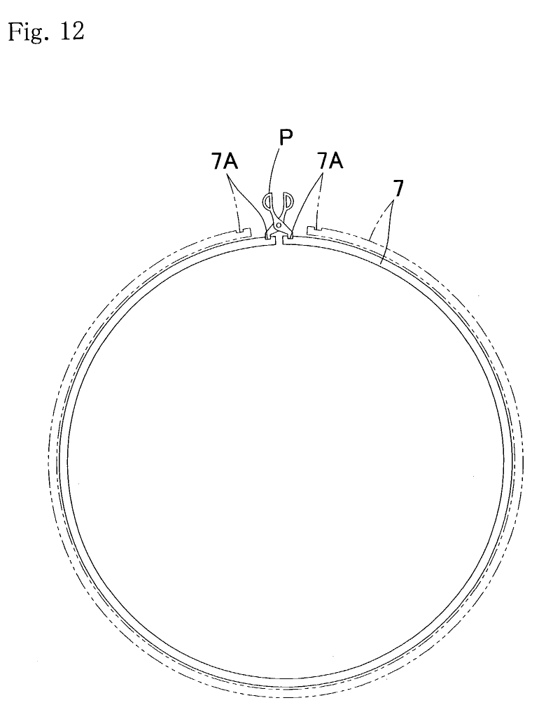

As is shown in FIG. 12, in cases where the abovementioned stopper member 7 is constructed from an annular (ring-form) metal part that is free at both ends, the tip ends of a tool P such as a pair of grip pliers or the like are first anchored in recessed parts 7A, 7A formed in both ends of the stopper member 7, and the stopper member 7 is caused to contract in the direction of diameter from the two-dot chain line in FIG. 12 as indicated by the solid line, so that the stopper member 7 is installed in the recessed part 3S of the spigot 3 (see FIG. 11(a)). In this state, the socket 2 of another coupling-equipped pipe 4 is inserted into the spigot 3 of the coupling-equipped pipe 4 on which the stopper member 7 is mounted; then, the tool P is removed at the point in time at which the tip end of the socket 2 passes over the stopper member 7 as shown in FIG. 11(b), thus resulting in a state in which the stopper member 7 expands outward as a result of the elastic recovery force of the stopper member 7, so that the stopper member 7 is fastened by a pressing contact force to the recessed part on the inside of the projecting part 2E of the socket 2. Then, the socket 2 is moved further in the direction indicated by the arrow, so that insertion (connection) is completed in a state in which the tip end of the socket 2 contacts the upper end of the step part 3F of the spigot 3. Furthermore, even if the spigot 3 should attempt to move in the slip-out direction, the abovementioned stopper member 7 contacts the side part of the projecting part 3G, so that this movement is checked. Here, a case is shown in which the abovementioned stopper member 7 is installed by moving the stopper member 7 from the spigot 3 toward the socket 2; however, it would be possible to install the stopper member 7 in a state in which the stopper member 7 is completely fastened to either the spigot 3 or socket 2. The other constructions shown in FIGS. 11(a), 11(b) and 11(c) are the same as that shown in FIG. 6; accordingly, the same symbols are assigned, and a description is omitted.

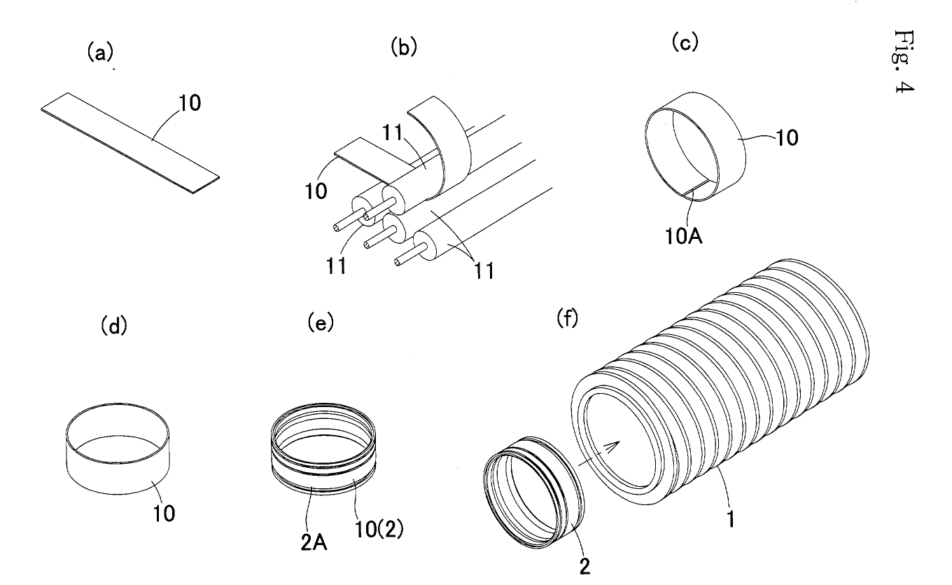

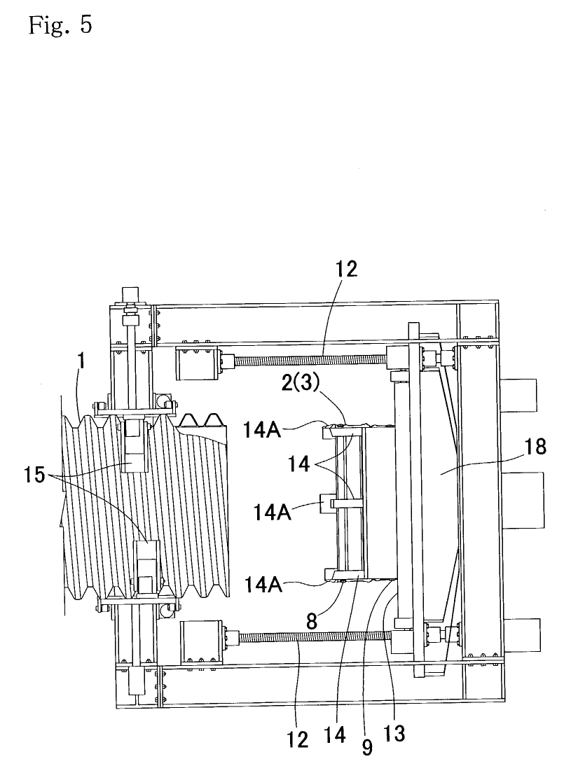

Next, the procedure used to manufacture the abovementioned coupling-equipped pipe 4 will be described. As is shown in FIG. 4(a), a band-form steel plate 10 formed with a specified length is formed into a cylindrical shape as shown in FIG. 4(c) using a plurality of bending rollers 11 (four rollers in the figure) constructed so as to allow free vertical movement as shown in FIG. 4(b). Next, the joint portions 10A at both ends of the steel plate 10 are welded by means of an automatic welding apparatus, and the portion that is piled upward by welding is flattened by means of (for example) a welding bead finishing machine (see FIG. 4(d)). Then, the recessed and projecting parts 2A through 2E or 3A through 3I shown in FIG. 2 are formed in the cylindrical body 10 by means of a bead working machine, thus manufacturing the abovementioned socket 2 or spigot 3 (see FIG. 4(e)). Then, a coupling-equipped pipe 4 can be manufactured by inserting the socket 2 or spigot 3 thus obtained into a pipe main body 1 using the press-fitting apparatus shown in FIG. 5 (see FIG. 4(f)).

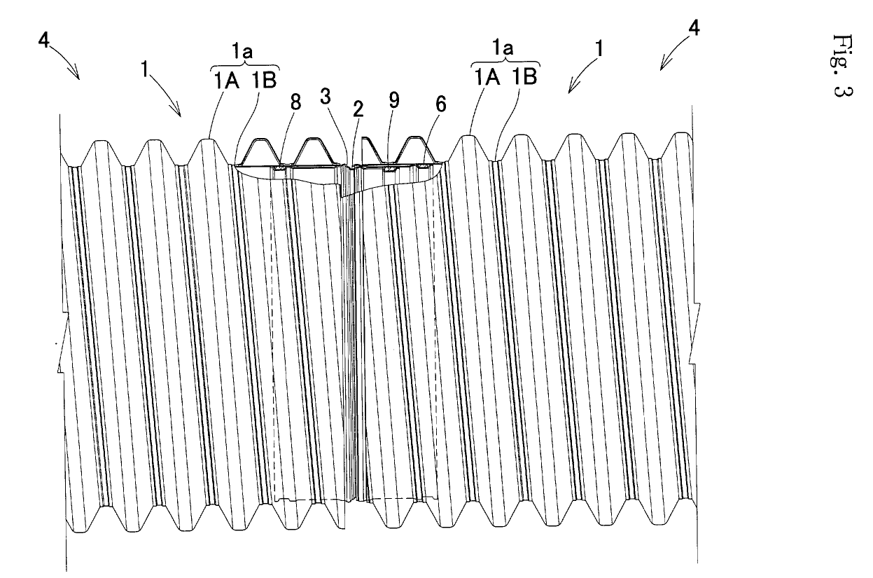

The abovementioned press-fitting apparatus will be described in detail. As is shown in FIG. 5, numerous anchoring arms 14 which can move inward in the direction of diameter and which have tapered anchoring parts 14[A] that are anchored on the tip end of the abovementioned socket 2 or spigot 3 are disposed at a specified pitch in the circumferential direction on a flat supporting body 13 which is attached to the tip end of a cylindrical press-fitting driving base 18 that is supported on screw shafts 12, 12 installed above and below so that this base 18 can be caused to move to the left or right in the figure by the rotation of the screw shafts 12, 12. Accordingly, as is shown in FIG. 5, the pipe main body 1 is placed in a state in which this pipe main body is held by numerous clamps 15, and the socket 2 or spigot 3 is anchored and held in a state in which the tip end surface of this part contacts the rear ends of the anchoring parts 14A of the anchoring arms 14. In this state, the screw shafts 12, 12 are rotated so that the press-fitting driving base 18 is caused to move to the left, thus causing the socket 2 or spigot 3 to be inserted into the pipe main body 1 via the opening in one end of the pipe main body 1. After the abovementioned anchoring arms 14 are released from the socket 2 or spigot 3, the mounting of the socket 2 or spigot 3 in the pipe main body 1 can be completed by returning the press-fitting driving base 18 to its initial position on the right side. Furthermore, the external diameter of the abovementioned socket 2 or spigot 3 is set at a dimension that is slightly larger than the internal diameter of the pipe main body 1; in this way, the dimensions of the socket 2 or spigot 3 and pipe main body 1 are set so that there is no great deformation of the pipe main body 1 outward in the direction of diameter when the socket 2 or spigot 3 is inserted into the pipe main body 1. Here, a case is shown in which the receptacle part 2 or spigot 3 is forcibly inserted into the pipe main body 1 by the press-fitting device. For example, however, it would also be possible to set the external diameter of the socket 2 or spigot 3 at a dimension that is slightly smaller than the internal diameter of the pipe main body 1 so that the socket 2 or spigot 3 can easily be inserted into the pipe main body 1, and to mount the socket 2 or spigot 3 in the pipe main body 1 by pushing open the tip end portion of the socket 2 or spigot 3 with respect to the direction of insertion, i.e., the end portion on which the sealing material 6 or 8 is disposed, by means of a pipe expanding device (a device which is used to push open the pipe to the outside in the direction of diameter) after the socket 2 or spigot 3 has been inserted into the pipe main body 1. Furthermore, method shown in FIGS. 1 through 3 and FIGS. 6 through 15 whereby the socket 2 or spigot 3 is mounted in the pipe main body 1 may use mounting by means of the abovementioned press-fitting device or mounting by means of the abovementioned pipe expanding device.

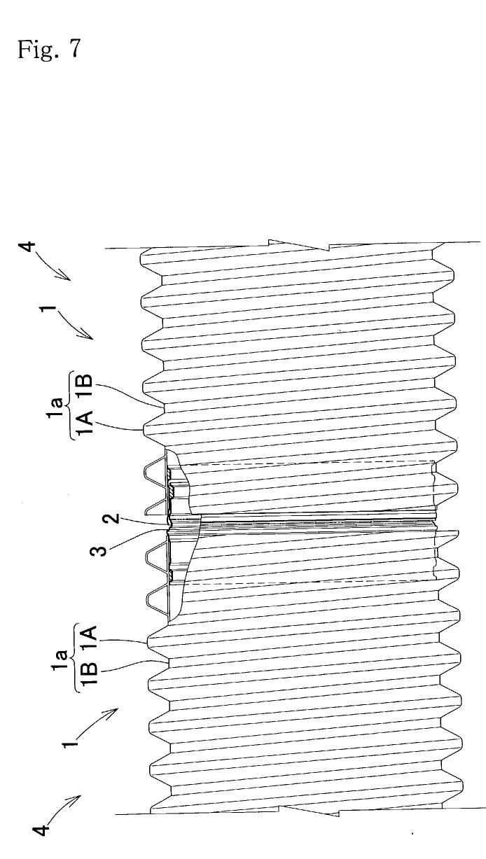

A large-caliber coupling-equipped pipe 4 was shown in FIGS. 1 through 3; however, this pipe may also be a small-caliber coupling-equipped pipe 4 as shown in FIGS. 6 and 7. Specifically, the diameter and length (in the axial direction of the pipe) of the socket 2 or spigot 3 shown in FIGS. 6 and 7 are merely smaller than those of the parts shown in FIGS. 1 through 3; the shapes of these parts are exactly the same. Accordingly, the same symbols are assigned, and a description is omitted. Furthermore, the pipe main body 1 shown in FIGS. 6 and 7 has no metal reinforcing members 5; however, a pipe main body 1 which has metal reinforcing members 5 may also be used.

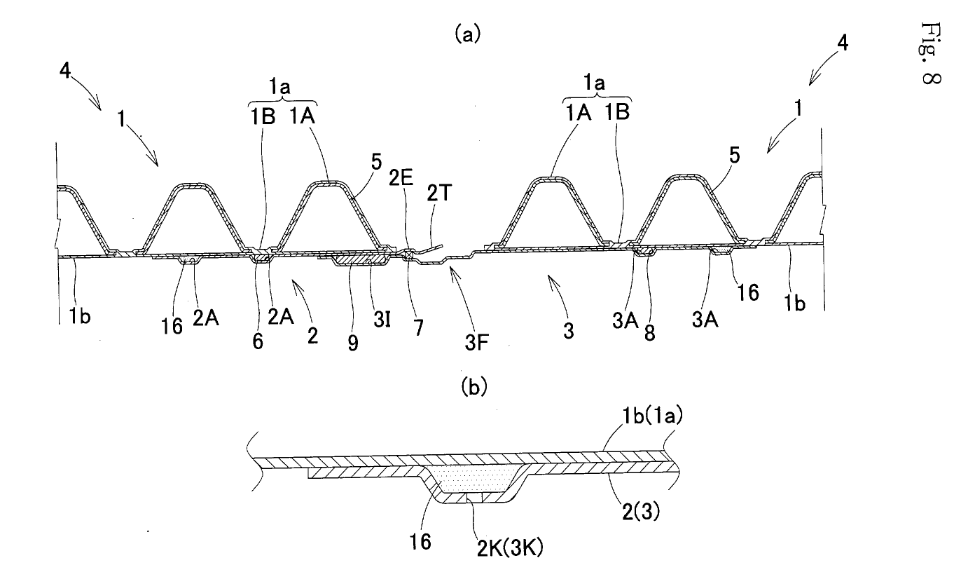

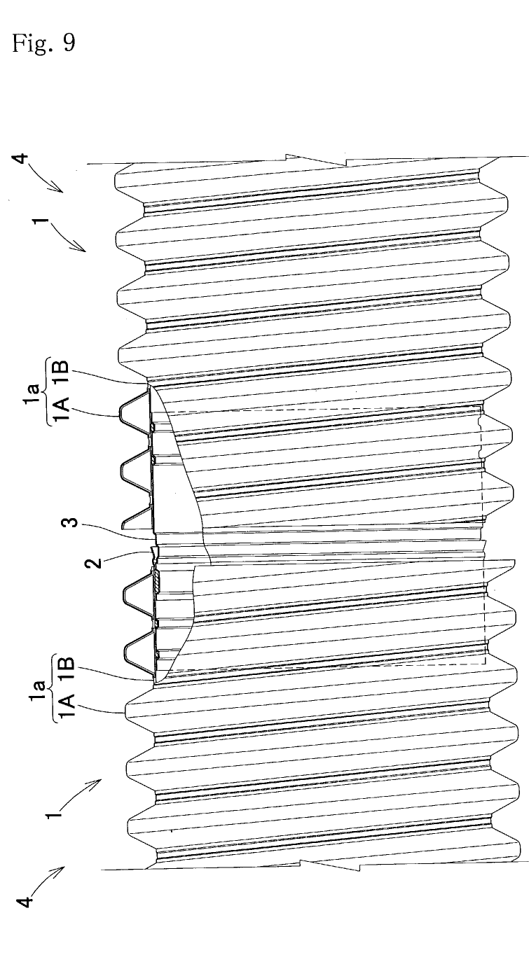

Furthermore, in FIGS. 1 through 7, the socket 2 or spigot 3 is installed by being inserted (press-fitted) in the pipe main body 1, and the movement of the socket 2 or spigot 3 relative to the pipe main body 1 is checked only by the frictional force between the outside surface of the socket 2 or spigot 3 and the inside surface of the pipe main body 1. However, for example, it would also be possible to use a construction such as that shown in FIGS. 8(a) and 8(b) and FIG. 9. Specifically, [in this construction,] recessed parts 2A are respectively formed in two places (in the axial direction of the pipe) in the base end part of the socket 2 or spigot 3 (here, a socket 2 is shown in the enlarged view), and the abovementioned annular sealing material 6 or 8 is attached to one recessed part 2A or 3A among the abovementioned recessed parts 2A or 3A (the recessed part on the side of the tip end portion in the figures), while the other recessed part 2A or 3A is filled with a molten resin 16 via an opening 2K or 3K formed in the socket 2 or spigot 3 (only one opening is shown in the figures; however, a plurality of openings may be formed). Then, the abovementioned filling molten resin 16 is caused to adhere to the pipe main body 1 and is solidified, so that this can be caused to function as a checking member that checks the movement of the socket 2 or spigot 3 with respect to the pipe main body 1. Accordingly, even in cases where a force in the direction that causes slipping out acts on the socket 2 or spigot 3, the movement of the socket 2 or spigot 3 relative to the pipe main body 1 can be securely checked by the abovementioned checking member 16. Furthermore, by constructing the synthetic resin that is used to form the pipe main body 1 and the filling molten resin 16 from the same type of resin, it is possible to increase the adhesive strength between the two resins. Moreover, the tip end portion 2T of the abovementioned socket 2 is formed with a tapered shape that expands outward toward the tip end, so that the spigot 3 can easily be inserted into the socket 2. Furthermore, the remaining parts are the same as those described above; accordingly, the same symbols are assigned, and a description is omitted.

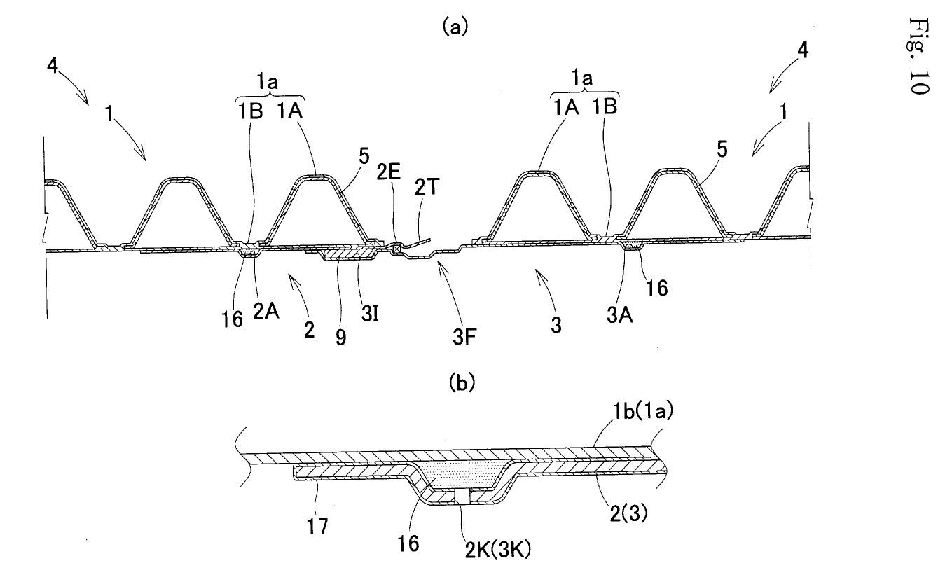

Furthermore, as is shown in FIGS. 10(a) and 10(b), the front surfaces or back surfaces of the abovementioned socket 2 and spigot 3, or both the front surfaces and back surfaces, are coated with a synthetic resin so that a covering layer 17 is formed, and the recessed part 2A or 3A is filled with a molten resin 16 via the opening 2K or 3K formed in the socket 2 or spigot 3 in a state in which the socket 2 or spigot 3 on which this covering layer 17 has been formed has been inserted into the pipe main body 1. Then, the abovementioned filling molten resin 16 is caused to adhere to the pipe main body 1 and covering layer 17, and is solidified, so that this can be caused to function as a checking member that checks the movement of the socket 2 or spigot 3 relative to the pipe main body 1; furthermore, the sealing treatment of the pipe main body 1 can be completed at the same time. Accordingly, the following advantage is obtained: specifically, even in cases where a force in the direction that causes slipping out acts on the socket 2 or spigot 3, the movement of the socket 2 or spigot 3 relative to the pipe main body 1 can be securely checked by the abovementioned checking member 16, and at the same time, the sealing treatment can also be completed. Furthermore, by constructing the synthetic resin that is used to form the pipe main body 1, the synthetic resin that is used to form the covering layer 17 and the filling molten resin 16 from the same type of resin, it is possible to increase the adhesive strength of the three resins. Moreover, the remaining parts are the same as those in FIGS. 8(a) and 8(b); accordingly, the same symbols are assigned, and a description is omitted.

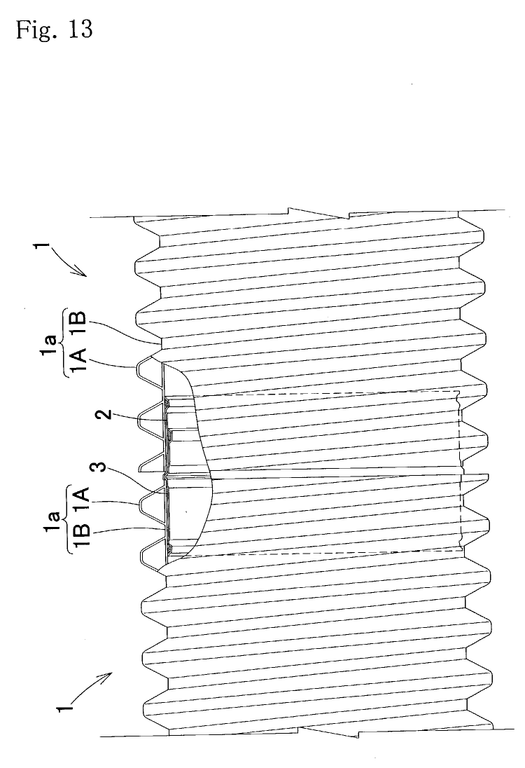

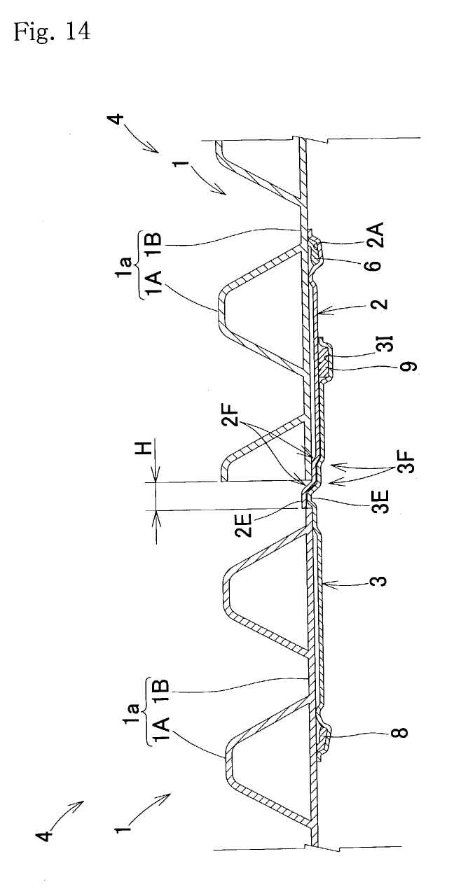

A case in which the abovementioned stopper member 7 is omitted is shown in FIGS. 13 and 14. In this case, there is no need to form a recessed part for installing the stopper member 7 in the socket 2 or spigot 3; accordingly, the length of the half coupling in the axial direction of the pipe can be shortened, and the structures of the socket 2 and spigot 3 can be simplified. Furthermore, the exposed range H to the outside of the coupling in the axial direction of the pipe when the socket 2 and spigot 3 are inserted and connected can be reduced, so that deformation of the connection area due to the effects of earth pressure can be suppressed. 3E and 2E shown in the figures are projecting parts which are used to regulate the insertion depth when the spigot 3 or socket 2 is inserted into the pipe main body 1. Furthermore, 2F is a step part which has two step parts formed in the socket 2 in order to regulate the insertion position of the socket 2 by contacting the step part 3F (with two step parts) of the socket 3. This step part 2F not only regulates the insertion position in a secure manner, but also makes it possible to increase the strength of the socket 2 and spigot 3. Depending on the diameter of the pipe main body 1, only a single step part 2F or 3F may be used.

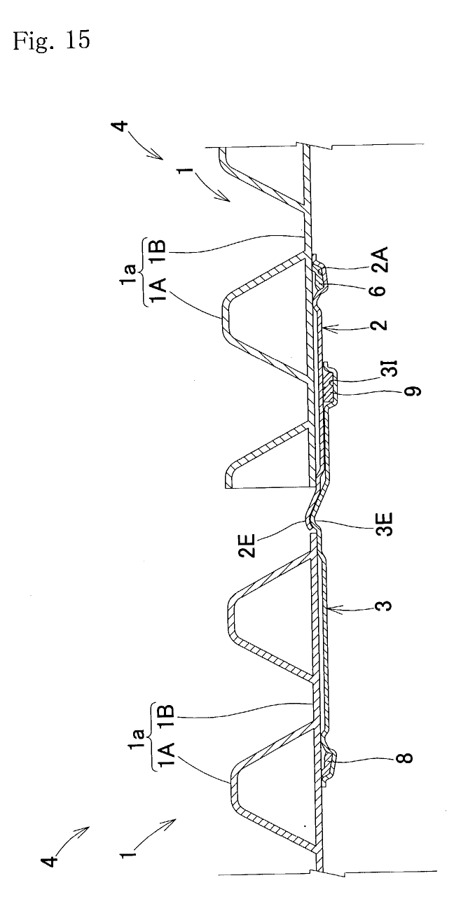

FIGS. 13 and 14 show a case in which the means used to prevent slipping out of the socket 2 and spigot 3 are omitted. As is shown in FIG. 15, an annular projecting part 2E which is gradually expanded in diameter toward the outside tip end portion and which is constricted inward at the tip end is formed in a protruding part that protrudes toward the outside in the axial direction of the pipe form the end portion of the socket 2, and an anchoring projecting part 3E which has an external diameter that is slightly larger than the internal diameter of the abovementioned projecting part 2E, and which protrudes to the outside in the axial direction of the pipe form the end portion of the spigot 3 is formed in the spigot 3 in order to achieve anchoring to the inside of the abovementioned projecting part 2E. Accordingly, when the spigot 3 is inserted into the socket 2, the projecting part 2E of the socket 2 is elastically deformed toward the outside in the direction of diameter of the pipe so that the projecting part 3E of the spigot 3 is anchored and held, thus forming means that prevent the slipping out of the socket 2 and spigot 3. Furthermore, the abovementioned means that prevent slipping out are not limited to the means shown in FIG. 15, but may consist of other means for preventing slipping out. The remaining constructions shown in FIG. 15 are the same as those shown in FIGS. 13 and 14; accordingly, the same symbols are assigned, and a description is omitted.

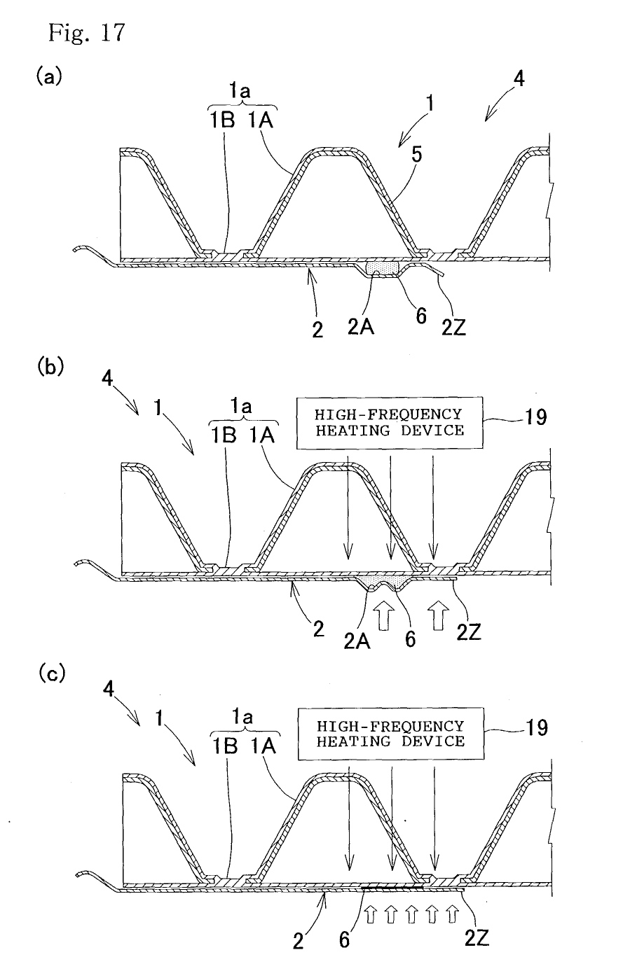

As is shown in FIGS. 17(a), 17(b) and 17(c), the abovementioned annular sealing material 6 with a more or less rectangular cross-sectional shape is constructed from a band-form member consisting of a synthetic resin that can be fused to a metal, and a high-frequency heating device 19 is provided which is used to fuse and fasten the abovementioned pipe main body 1 and socket 2 (or spigot 3) by heating and melting this band-form-member 6. In FIG. 17(a), after a band-form member 6 formed in an annular shape is fit into the annular recessed part 2A, or a single band-form member 6 is wrapped in the recessed part 2A and then the opposite end portions thereof are thermally fused together so that to be disposed in the recessed part 2A, the socket 2 is inserted into one end of the pipe main body 1 from the base end part as shown in FIGS. 2(a) and 2(b). Next, as is shown in FIG. 17(c), the entire base end part including the base end part 2Z bent toward the inside of the socket 2 (or spigot 3) and the recessed part 2A is pressed by means of the abovementioned press-fitting device or the like against the pipe main body 1 in the direction indicated by the arrow, so that the socket 2 (or spigot 3) is shaped into a more or less flat shape, thus pressing the band-form member 6 against the inside surface of the pipe main body 1. Or, as is shown in FIG. 17(b), the base end part 2Z that is bent inward and the center of the recessed part 2A are pressed in the direction indicated by the arrow, so that the band-form member 6 is caused to adhere tightly to the pipe main body 1. In this state, the strength of the connection between the pipe main body 1 and the socket 2 can be increased by melting the band-form member 6 by means of the high-frequency heating device 19; furthermore, even if the inside surface of the pipe main body 1 is a coarse surface which has small recesses and projections, these recesses and projections can be buried by the melted band-form member 6 so that the water-stopping performance can be improved. The abovementioned high-frequency heating device 19 may extend around the entire outer circumference of the pipe main body 1, or a heating device which heats only a portion of the outer circumference of the pipe main body 1 may be used. In cases where a heating device is used that heats only a portion of the circumference of the pipe main body 1, it is necessary to heat the pipe main body 1 by means of the high-frequency heating device 19 while rotating the pipe main body 1.

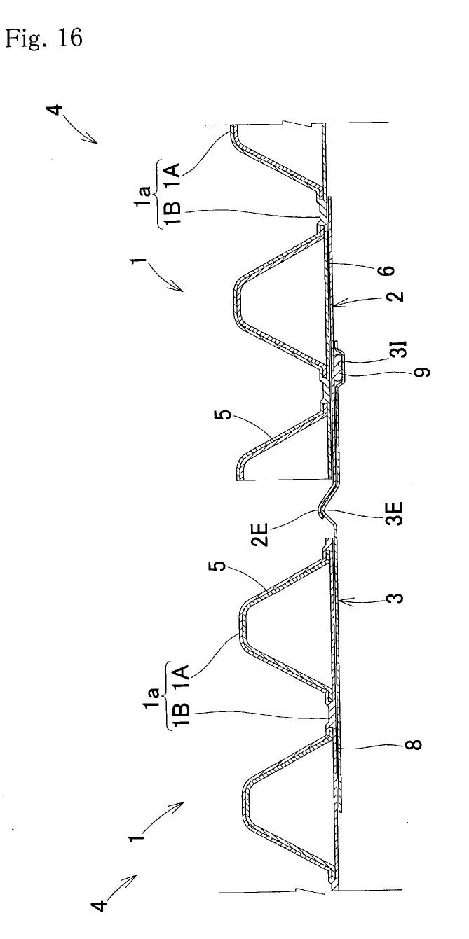

FIG. 16 shows a state in which a spigot 3 installed in another pipe main body 1 is inserted into a socket 2 installed in one pipe main body 1 as described above. The connection of the two coupling-equipped pipes 4 is then completed by the anchoring of the projecting part 3E formed in an intermediate portion of the spigot 3 with the projecting part 2E on the tip end of the socket 2. Furthermore, the sealing treatment with the socket 2 is completed by the sealing material 9 installed inside the recessed part 3I formed in the spigot 3 shown in FIG. 16.

Examples of synthetic resins that can be used to form the abovementioned band-form member 6 include EVA resins (ethylene-vinyl acetate resin copolymers) and EPDM (also called ethylene-propylene rubbers). However, any resin that is capable of fusion to a metal may be used. It is desirable that the melting point of the synthetic resin band-form member 6 used as the abovementioned band-form member 6 be lower than the melting point of the pipe main body 1 (polyethylene in this case). For example, the melting point of the HDPE (high-density polyethylene) that forms the abovementioned pipe main body 1 is 130° C. to 135° C., and the melting point of the EVA resin that forms the abovementioned band-form member 6 is 98° C. In this case, the band-form member 6 melts before the pipe main body 1, so that there is no trouble such as deformation of the pipe main body 1 or the like. In cases where the abovementioned EPDM is used, an unvulcanized rubber may be installed in the recessed part 2A of the socket 2, and this may be pressed against the socket 2 and vulcanized by heating with the high-frequency heating device 19, or a rubber sheet consisting of a vulcanized EPDM may be installed in the recessed part 2A of the socket 2.

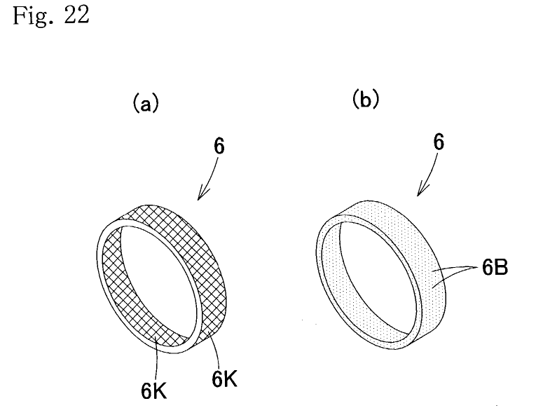

Besides being formed only from a synthetic resin that can fuse to a metal, the abovementioned band-form member 6 may be constructed as a conductive material by dispersing a conductive filler such as carbon black 6B, graphite, a powdered metal or the like in a highly concentrated state in a synthetic resin as shown in FIG. 22(b). Alternatively, a metal mesh 6K may be respectively installed on the front and back surfaces (or on only a single surface) of a band-form main body 6 consisting of a synthetic resin as shown in FIG. 22(a). As another alternative, although this is not shown in the figures, a metal mesh 6K may be installed in the interior of installed in the interior of a band-form main body consisting of a synthetic resin. In this way, the time required in order to melt the sealing material 6 by means of the high-frequency heating device 19 can be shortened by causing the conductive filler or metal mesh 6K to generate heat.

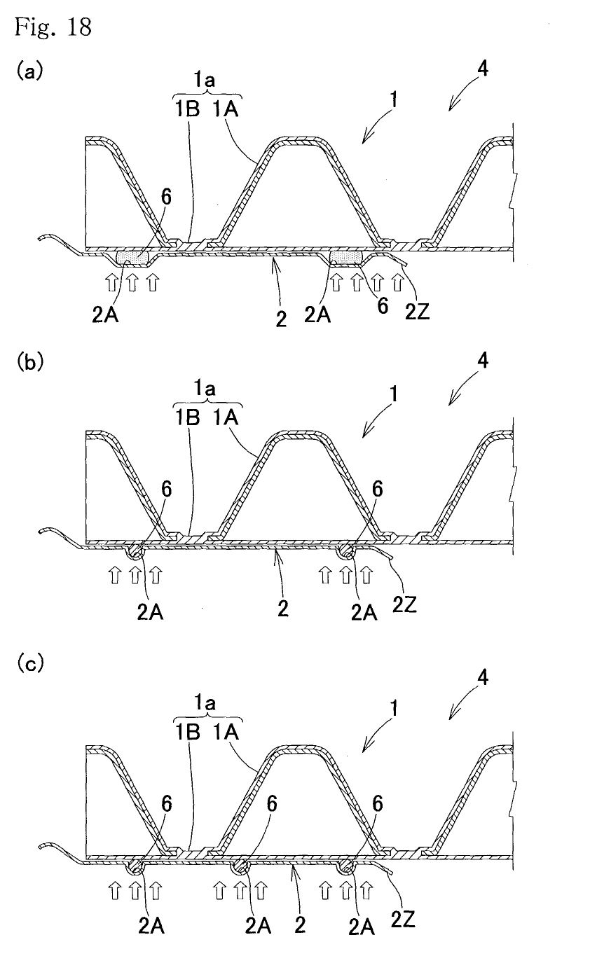

As is shown in FIG. 18(a), the abovementioned sealing material 6 may be installed in two places along the direction of length of the socket 2. In this case, two sealing materials 6, 6 are mounted inside the recessed parts 2A, 2A in the same manner as described above. Then, following insertion into the pipe main body 1 from one end, the two points consisting of the entire base end part (including one recessed part 2A of the socket 2 and the base end part 2Z that is bent to the inside) and the tip end part (including the other recessed part 2A) are pressed in the direction indicated by the arrow, after which the entire inside surface of the socket 2 is formed into a more or less flat surface, and fusion is subsequently accomplished by means of the high-frequency heating device (not shown in the figures) in the same manner as described above. FIG. 18(b) shows a configuration in which recessed parts 2A with a more or less semicircular cross-sectional shape are formed in two places along the direction of length of the socket 2, and two sealing materials 6, 6 with a more or less circular cross-sectional shape are fit into these recessed parts 2A, 2A. In this case as well, after the two sealing materials 6, 6 are mounted in the recessed parts 2A, 2A in the same manner as described above, the socket 2 is inserted into the pipe main body 1 from one end, and fusion is subsequently accomplished by means of the high-frequency heating device (not shown in the figures) after two places including the base end part 2Z are pressed in the direction indicated by the arrow. FIG. 18(c) shows a configuration in which three of the sealing materials 6 shown in FIG. 18(b) are installed in the socket 2. In this case, three places including the base end part 2Z are pressed.

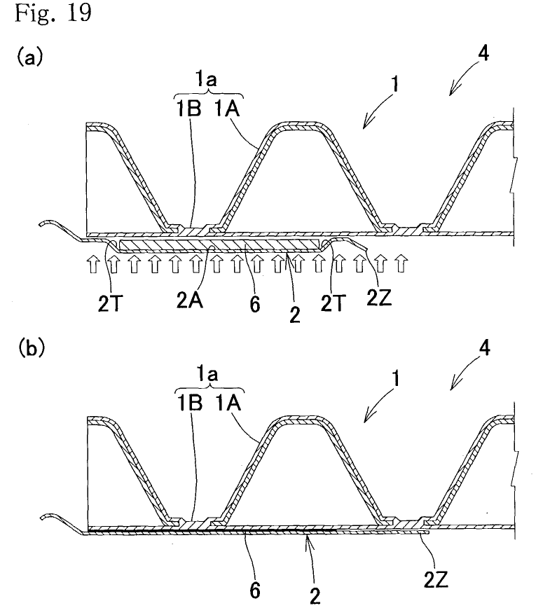

Furthermore, in FIG. 19(a) the sealing material may be a sealing material 6 which is longer than the sealing material shown in FIG. 18(a), i.e., which has a dimension that exceeds half the dimension of the socket 2 in the direction of length. In this case, a range extending across the base end part 2Z and the entire recessed part 2A is pressed in the direction indicated by the arrow shown in the figure, so that the entire inside surface of the socket 2 can be formed into a flat surface as shown in FIG. 19(b), and so that the sealing material 6 can be installed throughout most of the gap between the socket 2 and pipe main body 1, thus offering the advantage of increasing the connection strength. 2T, 2T shown in FIG. 19(a) indicate gradual tapered surfaces of the recessed parts 2A which are tapered toward the pipe main body as both ends of the socket 2 are approached. This configuration offers the advantage of making it possible to reduce the pressing force on the recessed parts 2A of the socket 2 compared to a configuration in which these surfaces are formed as more or less vertical surfaces.

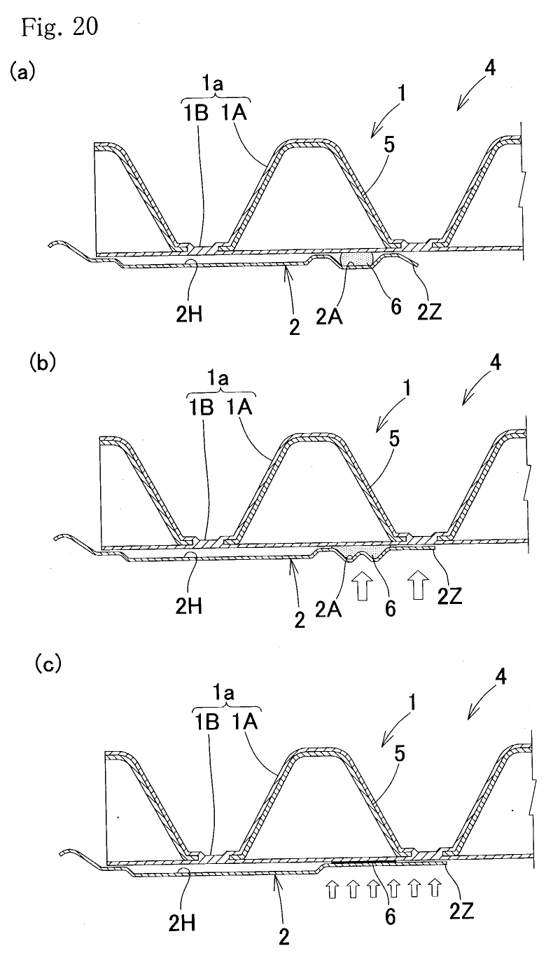

FIG. 20(a) shows a configuration in which an annular recessed part 2H that protrudes inward is formed in an intermediate portion (with respect to the direction of length) of the socket 2 shown in FIG. 17. As a result of the formation of a recessed part 2H in this way, the resistance with the outside surface of the socket 2 can be reduced when the socket 2 is inserted into the pipe main body 1, so that the advantage of easy insertion is obtained. After the abovementioned socket 2 has been inserted into the pipe main body 1, the base end part 2Z that is bent inward and the center of the recessed part 2A are pressed by means of the abovementioned press-fitting device or the like in the direction indicated by the arrow as shown in FIG. 20(b), so that the band-form member 6 is caused to adhere tightly to the pipe main body 1; alternatively, as is shown in FIG. 20(c), the entire base end part of the socket 2 (or spigot 3), i.e., the base and part 2Z and the recessed part 2A, are pressed against the main body part 1 in the direction indicated by the arrow, so that the portions of the socket 2 (or spigot 3) other than the abovementioned recessed part 2H are shaped into a more or less flat shape, thus pressing the band-form member 6 against the inside surface of the pipe main body 1. In this state, the band-form member 6 is melted by means of the high-frequency heating device 19.

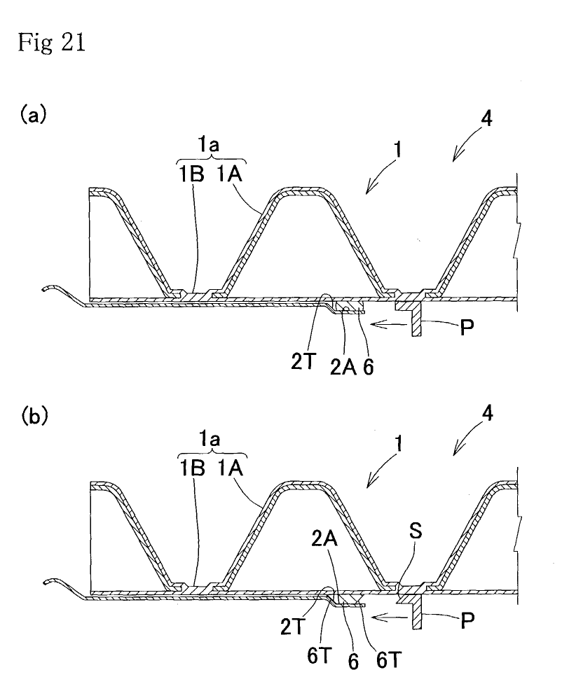

In the configurations shown in FIGS. 17 through 20, the sealing material 6 was pressed against the pipe main body 1 by pressing the socket 2 outward in the direction of diameter after the socket 2 was inserted into the pipe main body 1. However, as is shown in FIGS. 21(a) and 21(b), it would also be possible to use a construction in which the sealing material 6 is pressed against the pipe main body 1 by pressing the sealing material 6 by means of a pressing tool P that moves in the axial direction of the pipe (in the direction indicated by the arrow in the figure) without pressing the socket 2 outward in the direction of diameter. In this case, a pressing tool P which has a flattened pressing surface may be used for a sealing material which has a more or less rectangular cross-sectional shape as shown in FIG. 21(a), or a pressing tool P which has a tapered pressing surface S may be used for a sealing material 6 with a more or less trapezoidal cross-sectional shape which has tapered surfaces 6T formed by cutting both ends (with respect to the axial direction of the pipe) at an inclination as shown in FIG. 21(b). The recessed parts 2A shown in FIGS. 21(a) and 21(b) are formed open at one end and with a tapered surface 2T at the other end so that the pressing tool P can be inserted from the axial direction of the pipe. Accordingly, in the case of FIG. 21(b), the following advantage is obtained: namely, a portion of the sealing material 6 enters the gap between the socket 2 and the pipe main body 1 via the tapered surface 2T as a result of the sealing material 6 being pressed by the pressing tool P, and the socket 2 and pipe main body 1 can be strongly connected by the fusion of the sealing material 6 that has entered this gap.

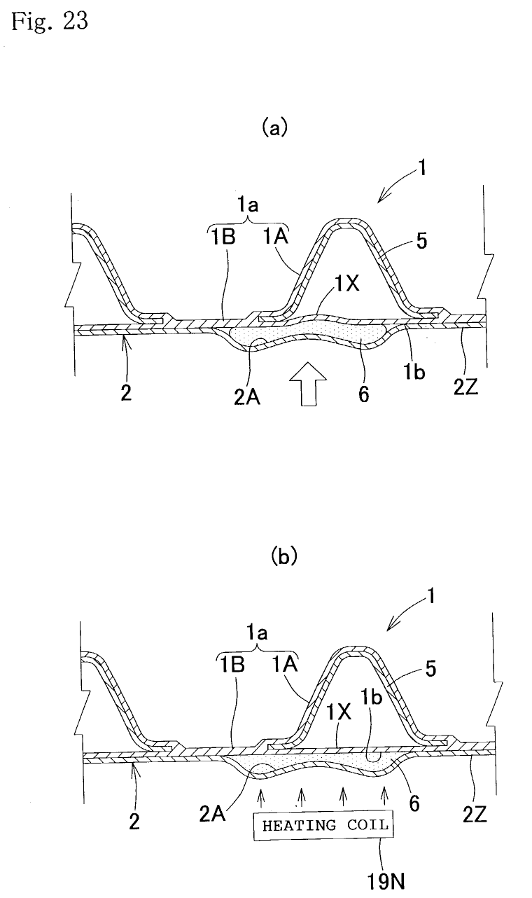

An enlarged view showing the center of the recessed part 2A of the socket 2 shown in FIG. 17(b) pressed in the direction indicated by the arrow is shown in FIG. 23(a); this will be described in detail. As is shown in FIG. 23(a), when the center of the recessed part 2A of the socket 2 is pressed in the direction indicated by the arrow, a specified portion 1X of the synthetic resin pipe main body 1 corresponding to the recessed part 2A receives this pressing force and is deformed slightly outward from the pipe center. In this state, the heating coil 19N constituting the abovementioned high-frequency heating device 19 is inserted into the socket 2, after which the heating coil 19N is driven, so that the band-form member 6 is melted. As a result, the pressing force against the pipe main body 1 is released so that the specified portion 1X of the pipe main body 1 returns to its original shape (a flat shape in the figures) as a result of the recovery force of this part. In this case, the band-form member 6 can be pressed against the socket 2, so that the adhesion can be increased; furthermore, a portion of the band-form member 6 is pushed out on both sides in the axial direction of the pipe, so that the interior of the recessed part 2A can be filled with the band-form member 6, thus greatly improving the sealing properties.

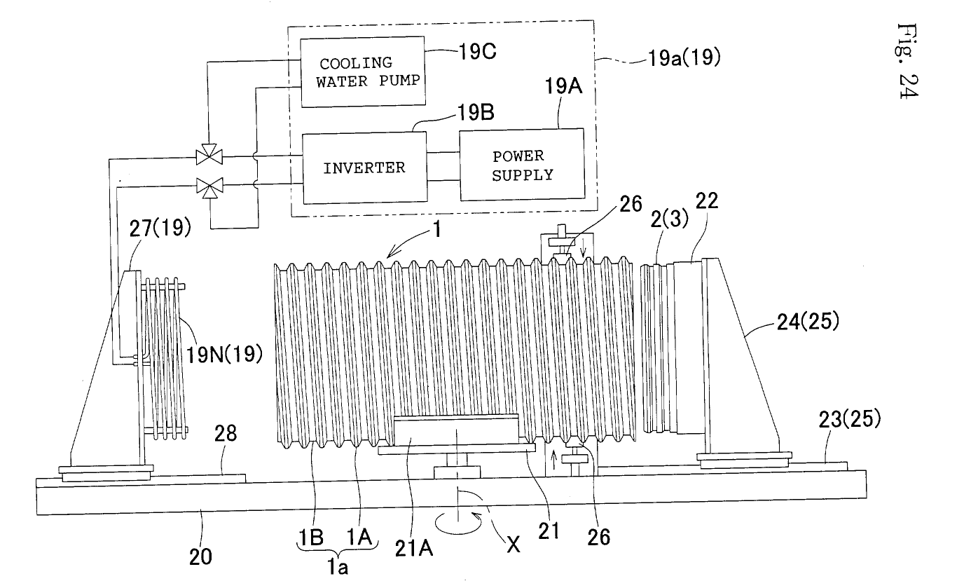

The manufacturing apparatus for the coupling-equipped pipe constructed as described above is shown in FIG. 24. The main constituent members of this manufacturing apparatus are a rotating stand 21 used as direction changing means which can carry the abovementioned pipe main body 1 on a stand 20 that is long in the lateral direction, and which can change the direction of the pipe main body 1 by 180 degrees by rotating [the stand] about a more or less vertical axis X by means of an electric motor (not shown in the figures), insertion means 25 consisting of a pipe expanding device moving stand 24 which carries the abovementioned pipe expanding device 22 that is used to expand the socket 2 or spigot 3, and which is free to move in the axial direction of the pipe relative to the pipe main body 1 via a sliding base 23, a pair of pipe fastening clamps 26, 26 (hereafter referred to as clamping members) which constitute fastening means for fastening the abovementioned pipe main body 1 to the rotating stand 21, and a heating station moving stand 27 constituting heating coil insertion means which are used to insert a heating coil 19N that forms a part of the high-frequency heating device 19 and that constitutes thermal diffusion means into the interior of the socket 2 or spigot 3 that is mounted in the abovementioned pipe main body 1. Furthermore, a circular-arc-form receiving part 21A which receives the bottom part of the pipe main body 1 is attached to the surface of the abovementioned rotating stand 21, so that there is no positional deviation of the pipe main body 1 during the rotation of the rotating stand 21.

The abovementioned heating station moving stand 27 is constructed so that this stand is free to move in the axial direction of the pipe via a sliding base 28. In addition to a capacitor and transformer (not shown in the figures), the abovementioned heating coil 19N is attached to the heating station moving stand 27. Furthermore, in addition to a power supply 19A and inverter 19B which are used to generate high-frequency waves by supplying electric power to the abovementioned heating coil 19N, a cooling water pump 19C which is used to supply cooling water to the interior of the hollow heating coil 19N is fastened in the vicinity of the abovementioned stand 20. A high-frequency generating device 19a is formed from the abovementioned power supply 19A, inverter 19B and cooling water pump 19C, and a high-frequency heating device 19 is constructed from this high-frequency generating device 19a, the abovementioned heating station moving stand 27 and the abovementioned heating coil 19N. Accordingly, the voltage from the power supply 19A is converted by the inverter into an alternating current output with a resonance frequency determined by the transformer, capacitor and the like, and this alternating current output is transformed by the transformer and input into the heating coil so that an electromotive force that is the inverse of the fluctuating magnetic field is generated in the object of heating (here, the socket 2 or spigot 3), thus causing the object of heating to generate heat by the Joule heat arising from the induced current that is generated, so that the sealing material 6 is melted, a portion of the inside surface of the pipe main body 1 is softened, and the socket 2 or spigot 3 is heated, thus making it possible to join the pipe main body 1 and socket 2 or spigot 3 by means of the sealing material 6.

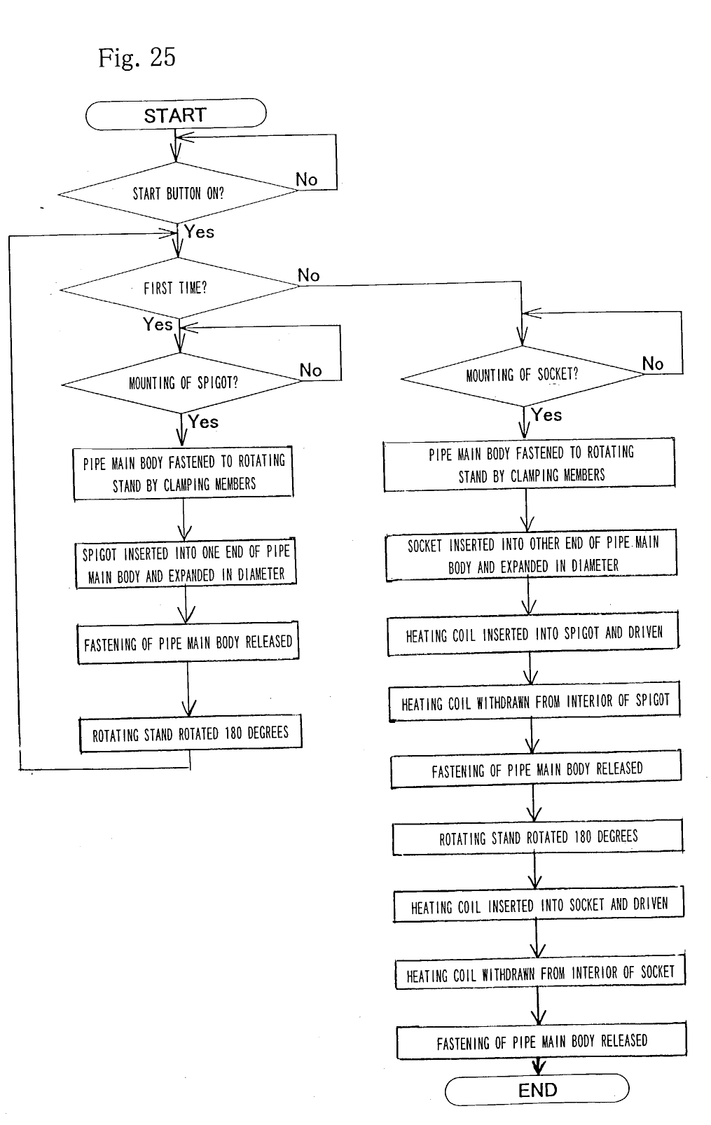

The manufacturing procedure used to manufacture a coupling-equipped pipe by means of the abovementioned coupling-equipped pipe manufacturing apparatus will be described on the basis of the flow chart shown in FIG. 25. First, the pipe main body 1 is placed on the rotating stand 21, and a spigot 3 (or socket 2) is mounted in the pipe expanding device 22. In this case, the apparatus is constructed so that a signal indicating that a spigot 3 has been mounted in the pipe expanding device 22 is output to a control device (not shown in the figures) by (for example) a limit switch (this may also be a non-contact type sensor or the like). In this state, when the start button of a control box (not shown in the figures) is pressed so that an ON signal is input into the control device, a judgement is made as to whether or not the rotation of the rotating stand 21 is the first time that rotation has occurred. If this is the first time, a check is made in order to ascertain whether or not a spigot mounting signal has been output from the abovementioned limit switch. In cases where a spigot 3 has been mounted, automatic operation is initiated, and the pipe main body 1 is first fastened to the rotating stand 21 by being clamped by the clamping members 26, 26 from above and below. Next, the pipe expanding device moving stand 24 is moved toward the pipe main body 1 via the sliding base 23, and the spigot 3 is inserted into one end of the pipe main body 1 as described above, after which the spigot 3 is expanded in diameter. When the mounting of the spigot 3 is completed, the fastening of the pipe main body 1 by the clamping members 26, 26 is released, after which the rotating stand 21 is rotated 180 degrees. A check is then again made in order to ascertain whether or not the rotation of the rotating stand 21 is the first time that rotation has occurred. Since this is the second time, there is a shift to the flow on the right side, and a check is made as to whether or not a socket 2 has been mounted by checking whether or not a socket mounting signal has been output from the limit switch in the same manner as described above. If a socket 2 has been mounted, the pipe main body 1 is fastened to the rotating stand 21 by being clamped by the clamping members 26, 26 from above and below, after which the pipe expanding device moving stand 24 is moved toward the pipe main body 1 via the sliding base 23, and the socket 2 is inserted into one end of the pipe main body 1 as described above, after which the socket 2 is expanded in diameter. Then, the heating station moving stand 27 is moved via the sliding base 28 to the side of the spigot 3 on the opposite side from the socket 2, so that the heating coil 19N is inserted into the spigot 3 and driven for a set time, thus melting the sealing material 6 so that the spigot 3 and pipe main body 1 are connected. After this is completed, the heating coil 19N is withdrawn to a waiting position (initial position shown in FIG. 24) from the interior of the spigot 3, the fastening of the pipe main body 1 by the clamping members 26, 26 is released, and the rotating stand 21 is rotated 180 degrees. Afterward, the heating coil 19N is inserted into the interior of the socket 2 and driven for a set time, so that the sealing material 6 is melted, thus connecting the socket 2 and the pipe main body 1. Subsequently, the heating coil 19N is withdrawn to the waiting position (initial position shown in FIG. 24) from the interior of the socket 2, after which the fastening of the pipe main body 1 by the clamping members 26, 26 is released, thus completing the manufacture of the coupling-equipped pipe. Furthermore, following this completion, the coupling-equipped pipe is removed from the rotating stand 21, and the next pipe main body 1 is set on the rotating stand 21, so that [another] coupling-equipped pipe is manufactured it he same manner as described above. [Here,] the apparatus is constructed so that the heating coil 19N was inserted into the spigot 3 following the mounting of the abovementioned socket 2; however, it would also be possible to shorten the manufacturing time by performing both of these operations simultaneously. Here, the system is arranged so that the coupling-equipped pipe manufacturing apparatus is automatically operated on the basis of output signals from detection means (limit switch or the like) which detect that the spigot 3 and socket 2 have been mounted in the pipe main body 1. However, it would also be possible to install a switch that moves the pipe expanding device moving stand 24 in order to mount the spigot 3 and socket 2 in the pipe main body 1, and a switch that is used to move the heating station moving stand 27 in order to insert the heating coil 19N into the spigot 3 or socket 2, and to perform the abovementioned operations manually.

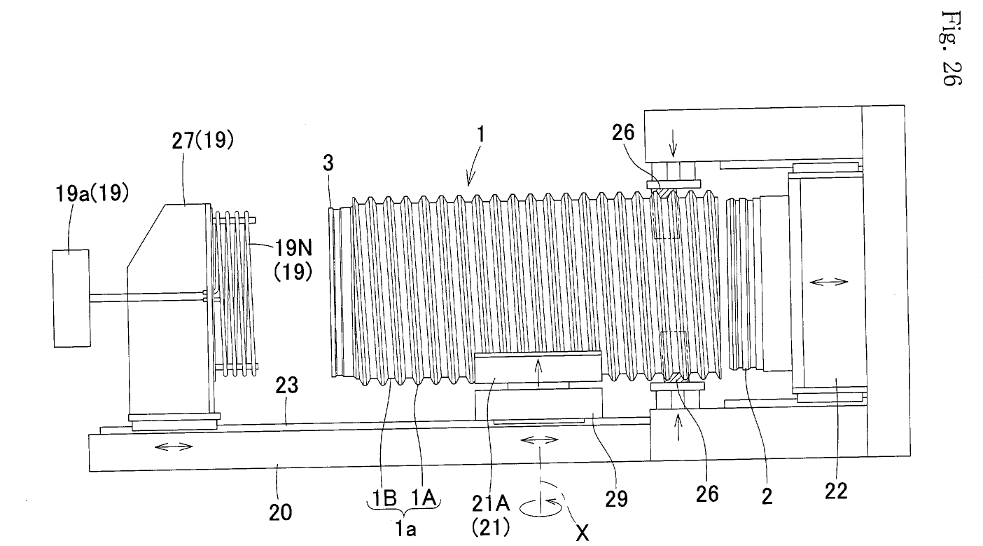

The abovementioned coupling-equipped pipe manufacturing apparatus may also be constructed as shown in FIG. 26. Specifically, the supporting frame of the upper and lower clamping members 26, 26 is constructed so that this frame also serves as a supporting frame for the pipe expanding device 22, and the pipe expanding device 22 is attached to this immobile supporting frame instead of being carried on a moving stand. Furthermore, the rotating stand 21 is constructed so that this stand also serves as the receiving part 21A, and a vertical driving device 29 which makes it possible to raise and lower this receiving part 21A by means of a hydraulic cylinder or the like is disposed directly beneath the receiving part 21A. The system is constructed so that the vertical driving device 29 can be moved via the abovementioned sliding base 23 which is disposed over more or less the entire region of the stand 20.

Accordingly, in a state in which the pipe main body 1 is carried on the receiving part 21A, the vertical driving device 29 can be moved via the sliding base 23 to a position that allows clamping by the upper and lower clamping members 26, 26 as shown in FIG. 26. Furthermore, in FIG. 26, the system is constructed so that the heating station moving stand 27 can move via the sliding base 23 in the same manner as described above. However, it would also be possible to omit the heating station moving stand 27, and to arrange the system so that the heating coil 19N is fixed and the pipe main body 1 is moved. Furthermore, in cases where sockets 2 and spigots 3 corresponding to pipe main bodies 1 of different diameters are mounted in such pipe main bodies 1, the system is arranged so that the height of the pipe main body 1 can be adjusted by the abovementioned vertical driving device 29, thus making it possible to cause the pipe axis of the pipe main body 1 to coincide with the centers of the socket 2 and spigot 3 and the center of the heating coil 19N, i.e., making it possible to always set the pipe axis at the same height regardless of the diameter of the pipe main body 1. Furthermore, the remaining parts that are not described are the same as the parts in FIG. 24, so that a description is omitted.

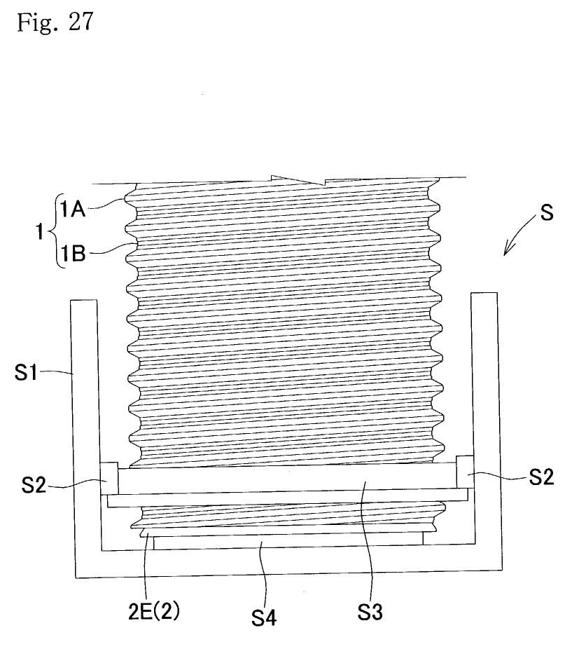

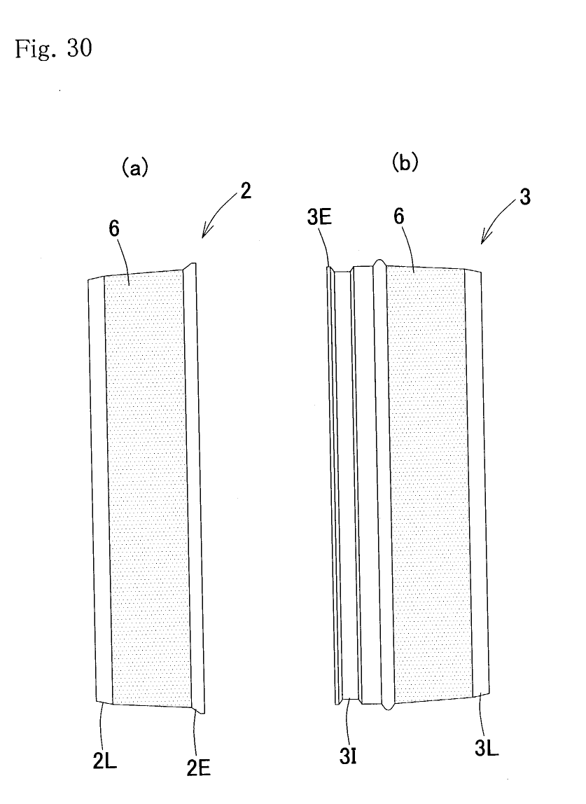

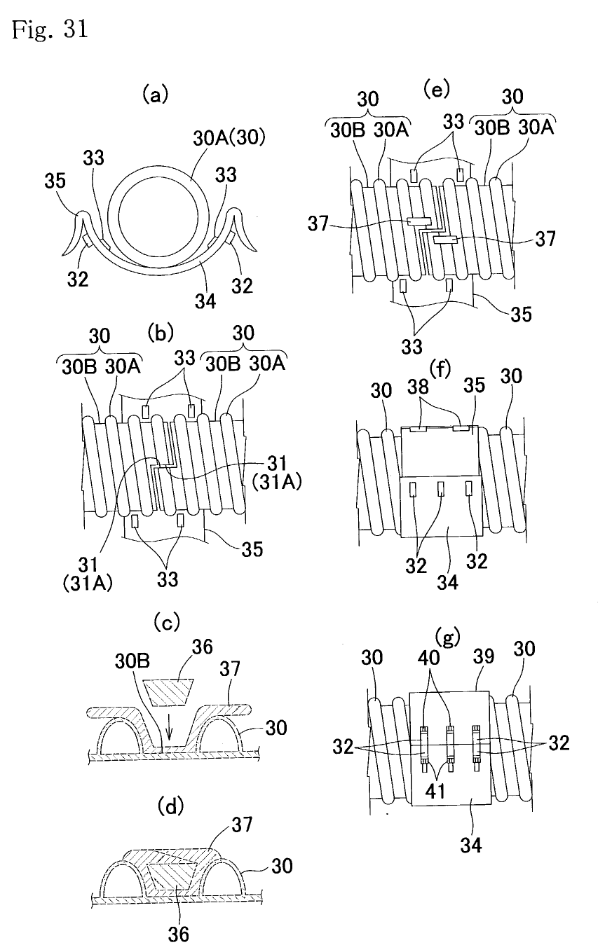

The abovementioned coupling-equipped pipe may also be constructed using the manufacturing apparatus shown in FIGS. 27 through 29(a) and 29(b). In concrete terms, as is shown in FIGS. 30(a) and 30(b), the socket 2 and spigot 3 are respectively constructed from tapered tubular bodies which have inclined surfaces that are inclined inward toward to the tip end with respect to the direction of insertion. An annular band-form thin-film sealing material 6 which has a certain width and which consists of a fusible synthetic resin is disposed on the outside surface of the abovementioned tubular body 2 or 3. The respective tip end portions 2L and 3L (with respect to the direction of insertion) of the abovementioned socket 2 and spigot 3 are formed with a tapered shape which has inclined surfaces in which the angle of inclination is greater than the angle of inclination of the other parts. The socket 2 and spigot 3 are constructed from tapered tubular bodies in which the outside surfaces from the tip ends to the projecting parts 2E and 3E formed on the base ends positioned on the opposite ends from the tip ends with respect to the axial direction of the pipe have the same angle of inclination.

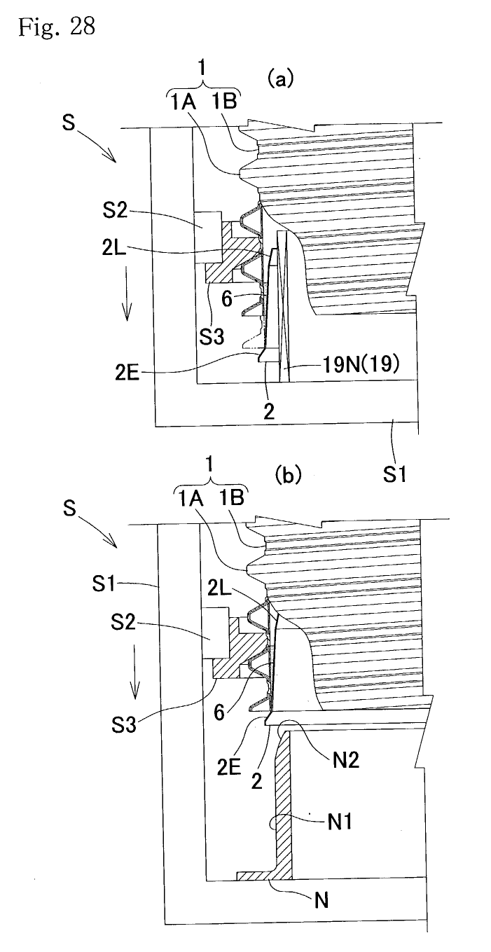

Furthermore, as is shown in FIGS. 27 and 28(a), a supporting device S is provided which can support the pipe main body 1 in a state in which the pipe main body 1 is placed in a vertical attitude in which the pipe axial direction of the pipe main body 1 is vertical, and which can move the supported pipe main body 1 in the vertical direction. In the abovementioned supporting device S, a pair of sliders S2, S2 (here there are two sliders; however, any number of sliders may be installed) which are free to slide in the vertical direction and which can be forcibly moved in the vertical direction by a driving device (not shown in the figures) are attached to the inside of a more or less U-shaped supporting stand S1 that supports the weight of the pipe main body 1. An annular (ring-form) anchoring member S3 which is anchored in a recessed part 1B formed in the abovementioned pipe main body 1 and used to hold the pipe main body 1 is detachably fastened to the sliders S2, S2 by means of bolts not shown in the figures (an anchoring mechanism or the like may also be used). Furthermore, the anchoring member S3 is installed in one end of the abovementioned pipe main body 1 by rotating the anchoring member S3 from one end of the pipe main body 1, and the anchoring member S3 of the pipe main body 1 placed in a vertical attitude is fastened by bolts from above (or from below) in a state in which the anchoring member S3 is pressed against the sliders S2, S2 from below, so that the anchoring member S3 is connected to the sliders S2, S2. Furthermore, in the figures, the anchoring member S3 installed in one end of the pipe main body is pressed against the sliders S2, S2 from below; however, it would also be possible to arrange the system so that the bolt fastening is facilitate by pressing the anchoring member 13 against the sliders S2, S2 from above so that the weight of the pipe main body 1 is supported by the sliders S2, S2.

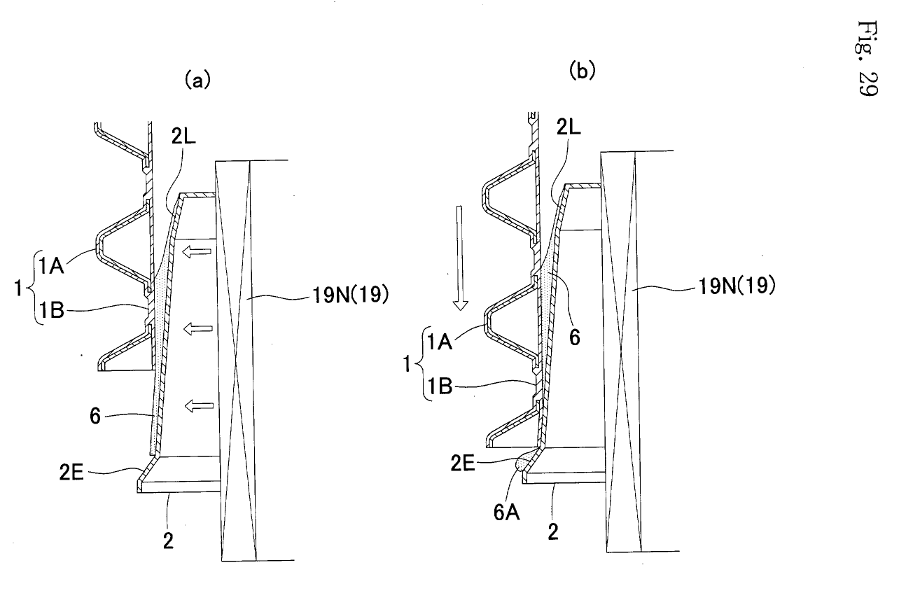

Accordingly, after the socket 2 is supported on the bottom plate part of the supporting stand S1 via a gap maintaining member S4 shown in FIG. 27 (this is not shown in FIG. 28(a)), the pipe main body 1 which has the anchoring member S3 installed in one end as described above is placed in a vertical attitude on the supporting stand Si, and this anchoring member S3 is fastened to the sliders S2, S2. Next, the pipe main body 1 is moved downward by moving the sliders S2, S2 downward, so that the tapered socket 2 is inserted from the tip end as far as a position that causes no expansion of the diameter of the pipe main body 1, i.e., a more or less central position with respect to the pipe axial direction of the socket 2 (i.e., this socket 2 is inserted as far as a position in which the outside surface of the socket 2 contacts the sealing material 6 on the inside surface of the end portion of the pipe main body 1 as indicated by the solid line in FIG. 28(a)). In this inserted state, the sealing material 6 is heated and melted (or heated and deformed) by the driving of the heating coil 19N (see FIG. 28(a)) of the abovementioned high-frequency heating device 19 which is positioned inside the socket 2; at the same time, the receptacle part 2 is inserted into the pipe main body 1 as far as a set position, i.e., a position located before the projecting part 2E on the base end portion of the socket 2 with respect to the direction of insertion, so that the end portion of the pipe main body 1 that has been softened by heating is easily deformed in to an outward-spreading shape as shown in FIG. 29(b), thus constructing a coupling-equipped pipe. Since the abovementioned socket 2 has a tapered shape, the tip end of the socket 2 with respect to the direction of insertion protrudes greatly into the interior of the pipe main body 1; accordingly, there is a danger of trouble such as the catching [of electrical wires] on the coupling-equipped pipe when wiring is run. In order to securely avoid this problem, it is desirable that the coupling-equipped pipe constructed as described above be moved downward (using the sliders S2, S2) with respect to a pressing member N which has on its tip end a tapered surface N2 that is tapered inward toward the tip end, and in which a rectilinear pressing surface N1 is formed from this tapered surface N2 to the base end portion, as shown in FIG. 28(b), so that the insertion part of the socket 2 that is inserted into the pipe main body 1 has a straight surface with the same diameter at all positions in the direction of the pipe axis, as shown in FIG. 19(b). Furthermore, FIG. 29(b) shows a state in which the excess sealing material 6A is pushed out to the outside when the socket 2 is inserted into the abovementioned pipe main body 1. As a result of the pipe main body 1 being placed in a vertical attitude as described above, a portion of the sealing material 6 melted by heating moves downward as a result of its own weight, so that the sealing material 6 can be securely concentrated in the sealing location as shown in FIG. 29(a), thus offering the advantage of secure sealing. However, the receptacle part 2 and pipe main body 1 may also be connected with both of these parts placed in a horizontal attitude.

When the mounting of the socket 2 in the abovementioned pipe main body 1 is completed, the pipe main body 1 is inverted and the spigot 3 is similarly inserted into the end portion on the opposite end from the socket 2 as described above; accordingly, a description is omitted.

In the invention according to claim 1 or claim 2, the ends of two pipes can be connected to each other merely by inserting the spigot installed in one connecting end of the pipe main body of one pipe into the socket installed in one end of the pipe main body of another pipe. Accordingly, the numerous members required for a conventional connection become unnecessary; furthermore, especially in the case of large pipe that have a considerable weight, it becomes unnecessary to lift the large pipes. Accordingly, this is advantageous in terms of construction in which connection work can be performed quickly and easily; furthermore, this is also advantageous in terms of handling including costs and transportation. Moreover, since this is a construction in which connection is accomplished by inserting a spigot into a socket, there is no formation of Z-shaped notches as in conventional systems; furthermore, the problem of water leakage caused by the formation of such notches can be securely solved, so that a coupling-equipped pipe with a high water-stopping performance can be obtained.

In the invention according to claim 3, a tapered socket or spigot is inserted into the pipe main body from the tip end as far as a position that causes no expansion of the diameter of the pipe main body. Then, in this inserted state, the sealing material is heated and melted or heated and deformed. As a result, this heat is also transmitted to the pipe main body so that the pipe main body can be placed in an easily deformable state. Then, by inserting the socket or spigot into the pipe main body as far as a set position in this state, the end portion of the pipe main body can be deformed into an outward-spreading shape in a state in which there is no generation of cracks or the like in this end portion. Accordingly, the following advantage is obtained: specifically, the generation of defective products can be greatly reduced compared to a construction in which the socket or spigot is merely forcibly inserted into the pipe main body. In particular, even in cases where the socket or spigot is mounted in a pipe main body which has an internal diameter that is smaller than the specified dimension, the end portion of the pipe main body can be deformed into an outward-spreading shape in a state in which there is no generation of cracks or the like in this end portion by inserting the tapered socket or spigot as described above into the pipe main body from the tip end as far as a position that causes no expansion of the diameter of the pipe main body, and then heating and melting or heating and deforming the sealing material in this state. Accordingly, dimensional differences in the internal diameter of the pipe main body can be absorbed in a favorable manner, so that manufacture to the same specifications can be accomplished, which is advantageous from the manufacturer's standpoint.

In the invention according to claim 4, as a result of the installation of plate-form reinforcing members in the form of bands on the projecting parts, the following advantage is obtained: specifically, not only it is possible to achieve a great improvement in the strength of the pipe main body, but the socket and spigot can be strongly fastened to the pipe main body as a result of receiving the elastic recovery force from the metal reinforcing members in a state in which the socket and spigot have been inserted into the pipe main body.

In the invention according to claim 5, as a result of the installation of a sealing material used to perform a sealing treatment between the socket and spigot on either the socket or spigot or both, the connection work can be completed at the same time that the insertion of the socket and spigot is completed, so that the speed of the connection work can be increased.

In the invention according to claim 6, as a result of the formation of recessed and projecting parts in the socket and the spigot, and the insertion of the socket and spigot provided with such recessed and projecting parts into the pipe main body, the strength of the end portions of the pipe main body can be increased by means of a socket and spigot in which the shape retention strength is greatly increased compared to parts which lack such recessed and projecting parts, and the strength can be increased even while reducing the weight.

In the invention according to claim 7, the recessed parts are constructed as attachment parts for the attachment of the sealing material that is used to form a seal with the pipe main body, and the projecting parts are constructed as regulating parts that are used to contact and regulate the positions at which the socket and spigot are inserted into the pipe main body. As a result, the number of parts required can be reduced and the assembly process can be shortened compared to cases in which such parts are formed as separate parts and attached to the socket and spigot. This is advantageous in terms of cost.

In the invention according to claim 8, the spaces formed between the recessed parts of the socket and spigot and the inside surface of the pipe main body are filled with a molten resin via one or more openings formed in the socket and spigot in a state in which the socket and spigot are inserted into the pipe main body. As a result, the solidified resin members inside the spaces can be caused to function as members that check the movement of the socket and spigot relative to the pipe main body, so that the degree of completeness (reliability) of the coupling-equipped pipe as a commercial product can be increased.

Furthermore, if a covering layer consisting of a synthetic resin is disposed on the outside surfaces of the socket and spigot as in claim 9, then the filling molten resin will fuse and adhere to the pipe main body and the covering layer on the socket and spigot, so that a sealing treatment between the pipe main body and socket and spigot can be accomplished, thus making a sealing material unnecessary.

In the invention according to claim 10, the inside surface of the pipe main body is formed as a flat surface. Accordingly, in cases where the coupling-equipped pipe is used as a drainage pipe (or sewer pipe), the drainage resistance can be alleviated; furthermore, in cases where the coupling-equipped pipe is used as an electrical wire conduit, smooth wire running work can be accomplished.

In the invention according to claim 11, the socket or spigot is mounted in the pipe main body by engagement (forcible insertion), or else the socket or spigot is inserted into the pipe main body, after which the socket or spigot is mounted by expanding the diameter of the socket or spigot. In addition, band-form members consisting of a synthetic resin that can fuse to a metal are melted by means of a high-frequency heating device, so that the pipe main body and socket or spigot are fused together. As a result, the slipping out of the socket or spigot as a result of the movement of the socket or spigot relative to the pipe main body can be avoided; furthermore, recessed parts such as fine striations or the like that are formed in the inside surface of the pipe main body during molding are buried, so that the sealing performance can be improved. Moreover, by pressing and deforming some or all of the attachment parts toward the outside in the direction of diameter from the center of the pipe using pressing deformation means prior to the melting of the band-form members by the high-frequency heating apparatus so that the band-form members are pressed against the pipe main body, it is not only possible to increase the connection strength between the pipe main body and the socket or spigot, but also possible to increase the sealing performance, so that a coupling-equipped pipe with high reliability can be provided.

In the invention of claim 12, a heating coil is disposed inside the socket or spigot. As a result, the socket or spigot can be heated more quickly than the pipe main body, so that trouble such as deformation of the pipe main body or the like can be avoided to a corresponding degree, thus making it possible to provide a coupling-equipped pipe in which there is little generation of defective products.

In the invention of claim 13, the band-form members are constructed by dispersing a conductive filler such as carbon black or the like in a synthetic resin, or by disposing a metal mesh on the front surface or back surface (or both surfaces) of a band-form main body consisting of a synthetic resin, or by disposing such a metal mesh inside a band-form main body consisting of a synthetic resin. As a result, not only is it possible to shorten the time required for melting by the high-frequency heating device, but a coupling-equipped pipe with superior performance in preventing slipping out and superior sealing performance can be obtained.

In the invention according to claim 14, a coupling-equipped pipe manufacturing apparatus which is used to mount two [opening parts, i.e., a] spigot and a socket, in the pipe main body is employed. As a result, the manufacture of coupling-equipped pipe can be accomplished with good precision and good efficiency, which is advantageous from the manufacturer's standpoint. Furthermore, since this is a construction in which the spigot and socket are mounted in the pipe main body by thermal fusion, a coupling-equipped pipe with superior performance in preventing slipping out and superior sealing performance can be obtained.

What is claimed is:

1. A coupling-equipped pipe which is made of a synthetic resin, and which is formed by inserting, into one end of a pipe main body which is formed in a spiral shape in which projecting parts and recessed parts are alternately positioned in the direction of the pipe axis, a tubular socket made of metal which has an external diameter that is larger than the internal diameter of said pipe main body, and by further inserting, into the other end of said pipe main body, a tubular spigot made of metal which has an external diameter that is larger than the internal diameter of said pipe main body, and which also has a tip-end insertion part that can be inserted into said socket and connected therewith.

2. A coupling-equipped pipe which is made of a synthetic resin, and which is formed by inserting, into one end of a pipe main body which is formed in a spiral shape in which projecting parts and recessed parts are alternately positioned in the direction of the pipe axis, a tubular socket made of metal which has an external diameter that is smaller than the internal diameter of said pipe main body, then expanding the diameter of at least a portion of said socket, and by further inserting, into the other end of said pipe main body, a tubular spigot made of metal which has an external diameter that is smaller than the internal diameter of said pipe main body, and which also has a tip-end insertion part that can be inserted into said socket and connected therewith, then expanding the diameter of at least a portion of said spigot.

3. The coupling-equipped pipe according to claim 1, wherein said socket and spigot are respectively constituted by tubular bodies with a tapered shape that is tapered inward toward the tip end with respect to the direction of insertion, annular sealing members made of a fusible synthetic resin are provided to the outside surfaces of said tubular bodies, said tapered socket or spigot is inserted from the tip end into said pipe main body as far as a position where the diameter of said pipe main body is not thereby expanded, and in this inserted state, said socket or spigot is further inserted into said pipe main body, as far as a set position, while the sealing member is thermally fused or thermally deformed, whereby the end portion of said pipe main body is thermally deformed into a shape that spreads outward.

4. The coupling-equipped pipe according to claim 1, 2 or 3, wherein plate-form metal reinforcing members are disposed in the form of bands on the projecting parts of said pipe main body.

5. The coupling-equipped pipe according to claim 1, 2 or 3, wherein a sealing material is provided to at least one of the socket and the spigot, so that a sealing treatment is performed between the socket and spigot when these are connected.

6. The coupling-equipped pipe according to claim 1, 2 or 3, wherein recessed parts that are recessed inward in the direction of diameter of the pipe and projecting parts that protrude outward in the direction of diameter of the pipe are formed in said socket and spigot, and the socket and spigot that have these recessed parts and projecting parts are inserted into said pipe main body.

7. The coupling-equipped pipe according to claim 6, wherein said recessed parts are formed in an annular shape, these recessed parts are constructed as attachment parts for the attachment of the sealing material used for sealing to said pipe main body, and said projecting parts are constructed as regulating parts which are used to contact and regulate the positions at which said socket and spigot are inserted into said pipe main body.

8. The coupling-equipped pipe according to claim 6 or 7, wherein the spaces formed between the recessed parts of said socket and spigot and the inside surface of said pipe main body in a state in which said socket and spigot are inserted into said pipe main body are filled with a molten resin via a single opening or a plurality of openings formed in said socket and spigot.

9. The coupling-equipped pipe according to claim 8, wherein a covering layer made of a synthetic resin is disposed on the outside surfaces of said socket and spigot.

10. The coupling-equipped pipe according to any of claims 1 through 9, wherein the inside surface of said pipe main body is formed as a flat surface.

11. The coupling-equipped pipe according to claim 6, wherein said recessed parts are formed with an annular shape, these recessed parts are constructed as attachment parts for the disposition of a sealing material used for sealing to the pipe main body, the sealing material that is disposed inside these attachment parts is constructed from band-form members consisting of a synthetic resin that can be thermally fused to a metal, some or all of the attachment parts are pressed and deformed outward in the direction of diameter of the pipe from the center of the pipe by pressing deformation means, and the pipe main body and socket or spigot are connected by heating and fusing the band-form members inside the attachment parts by means of a high-frequency heating device in a state in which the attachment parts are deformed by the pressing deformation means.

12. The coupling-equipped pipe according to claim 11, wherein said sealing material is heated and fused by disposing a heating coil constituting said high-frequency heating device inside said socket or spigot.

13. The coupling-equipped pipe according to claim 11 or claim 12, wherein said band-form members are formed by dispersing a conductive filler such as carbon black or the like in a synthetic resin, disposing a metal mesh on either the front surface or back surface, or on both surfaces, of a band-form main body made of a synthetic resin, or disposing said metal mesh inside a band-form main body made of a synthetic resin.

14. An apparatus for manufacturing a coupling-equipped pipe, comprising:
a rotatable rotating stand capable of carrying a pipe main body which is made of a synthetic resin, and which is formed in a spiral shape in which projecting parts and recessed parts are alternately positioned in the axial direction of the pipe;
insertion means for inserting a tubular socket or spigot which is made of a metal and has a sealing material consisting of a synthetic resin that can be thermally fused to a metal inside a recessed part that is recessed inward in the direction of diameter of the pipe, said insertion means being provided at one of the two ends of the pipe main body with respect to the axial direction of the pipe carried on said rotating stand; and
heating coil insertion means provided at the other end of the pipe main body for inserting a heating coil that constitutes a high-frequency heating device into said pipe main body;
wherein the apparatus further comprises:
direction changing means which rotate said rotating stand after the socket or spigot has been inserted into said pipe main body by said insertion means so that said pipe main body is caused to undergo a change in direction of approximately 180 degrees; and
thermal fusion means for causing thermal fusion of said sealing material after said heating coil has been inserted into said socket or spigot following the change in direction of said pipe main body.
